(19) United States
(12) Patent Application Publication
(10) Pub. No.: US 2025/0171586 A1
(43) Pub. Date: May 29, 2025

(54) METHODS FOR MAKING AND USING POLYMACROLACTONES

(71) Applicants: Alliance for Sustainable Energy, LLC, Golden, CO (US); Amazon.com Services, LLC, Seattle, WA (US); Colorado State University Research Foundation, Fort Collins, CO (US)

(72) Inventors: Ryan William CLARKE, Wheat Ridge, CO (US); Katrina Marie KNAUER, Denver, CO (US); Vinod Kumar KONAGANTI, Vancouver (CA); Eugene Y. CHEN, Fort Collins, CO (US); Ravikumar RAMEGOWDA, Fort Collins, CO (US)

(21) Appl. No.: 18/960,580

(22) Filed: Nov. 26, 2024

Related U.S. Application Data
(60) Provisional application No. 63/603,504, filed on Nov. 28, 2023.

(51) Int. Cl. C08G 63/08; C08J 5/18

(52) U.S. Cl. CPC C08G 63/08; C08J 5/18; C08J 2367/06

(57) ABSTRACT

The present disclosure relates to polymers having Structure (I),

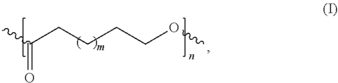

where m is between 8 and 20, n is between 2 and 5,000, and [symbol] is a covalent bond, methods of making the polymer, compositions that include the polymer, and methods of using the compositions.

### CROSS-REFERENCE TO RELATED APPLICATIONS

This application claims priority from U.S. Provisional Patent Application No. 63/603,504 filed on Nov. 28, 2023 and its associated appendix, the contents of which are incorporated herein by reference in their entirety.

### CONTRACTUAL ORIGIN

This invention was made with government support under Contract No. DE-AC36-08GO28308 awarded by the Department of Energy. The government has certain rights in the invention.

### BACKGROUND

The broad implementation and application of commercial biopolyesters is limited due to challenges such as lack of efficient production (leading to high production costs), inferior melt processability and mechanical properties, and poor recyclability potential. Many commercial biopolyesters are intrinsically thermally unstable, degrade at elevated temperatures, and loose molecular weight and/or viscosity during melt processing. This is at least partly due to the presence of α-hydrogens that promote facile cis-elimination to form an internal alkene and a carboxylic acid, causing a large, continuous drop in shear viscosity under melt-processing conditions. Further, the residual moisture in polyesters (if not dried properly) and unreacted carboxylic acids, can promote degradation by hydrolysis at elevated temperatures. The mechanical performance of commercial polyesters can also be limited due to narrow molecular tunability compared to commodity plastics (e.g., polyethylene and polypropylene). Therefore, to address these problems, the need remains to develop efficient methods capable of producing biopolyesters having enhanced material properties, processability, and performance characteristics that enable chemical recyclability and a circular plastics economy.

### SUMMARY

An aspect of the present disclosure is a polymer according to Structure (I),

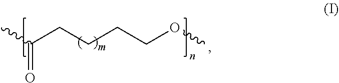

where m is between 8 and 20, n is between 2 and 5,000, and [symbol] is a covalent bond. In some embodiments of the present disclosure, the polymer may have a number average molecular weight (Mₙ) between 50 kDa and 500 kDa. In some embodiments of the present disclosure, the polymer may have a polydispersity (Ð) between 1.1 and 1.4.

In some embodiments of the present disclosure, the polymer may have a melting temperature (Tₘ) between 80.0° C. and 115.0° C. In some embodiments of the present disclosure, the polymer may have an enthalpy of fusion (ΔHₘ) between 60 J/g and 200 J/g. In some embodiments of the present disclosure, the polymer may have a crystallization temperature (T_{c}) between 60.0° C. and 150.0° C. In some embodiments of the present disclosure, the polymer may have an enthalpy of crystallization (ΔH_{c}) between 80 J/g and 200 J/g. In some embodiments of the present disclosure, the polymer may have a stress at break between 10 MPa and 80 MPa. In some embodiments of the present disclosure, the polymer may have a strain at break between 200% and 1500%. In some embodiments of the present disclosure, the polymer may have a Young's modulus between 100 MPa and 1500 MPa.

An aspect of the present disclosure is a composition that includes at least one of a heat stabilizer, an anti-oxidant, a processing aid, and/or an anti-blocking agent and a polymer according to Structure (I),

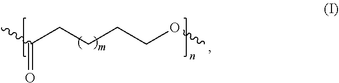

where m is between 8 and 20, n is between 2 and 5,000, and [symbol] is a covalent bond. In some embodiments of the present disclosure, the composition may be in the form of a film. In some embodiments of the present disclosure, the film may have an average thickness between 2.5 μm and 250 μm. In some embodiments of the present disclosure, the film may have a clarity value between 60% and 100%. In some embodiments of the present disclosure, the film may have a haze value less than 60%.

An aspect of the present disclosure is a method of making a polymer, where the method includes polymerizing a cyclic molecule having a structure according to (II) to produce the polymer having a structure according to (I), where

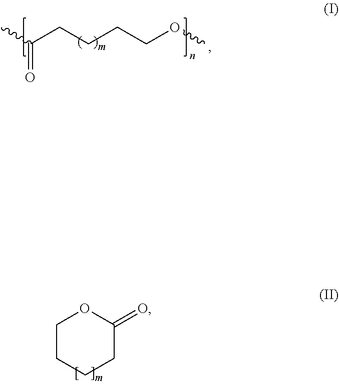

m is between 8 and 20, n is between 1 and 5,000, [symbol] is a covalent bond, and the polymerizing is performed neat. In some embodiments of the present disclosure, the polymerizing may result in between 80% and 100% conversion of the cyclic molecule. In some embodiments of the present disclosure, the polymer may be further characterized by a polydispersity (Ð) between 1.1 and 1.4. In some embodiments of the present disclosure, the polymerizing may be performed at a temperature between 70° C. and 110° C.

An aspect of the present disclosure is a method of using a composition to produce a film, where the composition includes a polymer comprising Structure (I),

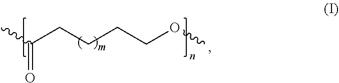

where m is between 8 and 20, n is between 2 and 5,000, and [symbol] is a covalent bond; and the method comprises directing the polymer to a blown film extruder, where the extruder is operated with: a barrel temperature between 150° C. and 250° C., a die temperature between 145° C. and 245° C., and an extruder speed between 60 RPM and 300 RPM, and where the extruder is a conical single screw extruder.

### BRIEF DESCRIPTION OF DRAWINGS

Some embodiments are illustrated in referenced figures of the drawings. It is intended that the embodiments and figures disclosed herein are to be considered illustrative rather than limiting.

FIG. 1 illustrates a method for synthesizing polymers, e.g., polymacrolactones, according to some embodiments of the present disclosure.

FIG. 2 illustrates a ¹H nuclear magnetic resonance (NMR) spectrum (CDCl₃) of pure isolated 92.6 kDa poly-15-hydroxypentadecanoate (PHPD) (134 g) (Experiment #1), according to some embodiments of the present disclosure.

FIG. 3 illustrates a gas permeation chromatography (GPC) trace of PHPD obtained from a neat polymerization (Mₙ=92.6 kDa, M_{w}=124 kg/mol, Ð=1.33) (Experiment #1), according to some embodiments of the present disclosure.

FIG. 4 illustrates isolated PHPD obtained from a neat polymerization (Mₙ=92.6 kDa, Mw=124 kg/mol, Ð=1.33) (Experiment #1), according to some embodiments of the present disclosure.

FIG. 5 illustrates a thermogravimetric analysis (TGA) trace of PHPD (Mₙ=92.6 kDa, Mw=124 kDa, Ð=1.33) (Experiment #1), according to some embodiments of the present disclosure.

FIG. 6 illustrates a TGA trace of PHPD (Mₙ=92.6 kDa, Mw=124 kDa, Ð=1.33) (thermal stability at 200° C. under air flow 40.0 mL/min, 2.7% weight loss after 2 hours) (Experiment #1), according to some embodiments of the present disclosure.

FIG. 7 illustrates a differential scanning calorimetry (DSC) trace of PHPD (Mₙ=92.6 kDa, Mw=124 kDa, Ð=1.33) (Experiment #1), according to some embodiments of the present disclosure.

FIG. 8 illustrates a dynamic mechanical analysis (DMA) trace of PHPD (Mₙ=92.6 kDa, M_{w}=124 kDa, Ð=1.33) (Experiment #1), according to some embodiments of the present disclosure.

FIG. 9 illustrates tensile testing of compression molded PHPD (Mₙ=93.6 kDa) films with three replicates at a strain rate of 5 mm/min (Experiment #1), according to some embodiments of the present disclosure. Stress, strain, and Young's modulus values for each of the three replicates are tabulated in Table 4A.

FIG. 10 illustrates shear viscosity versus time at 120° C. (PHPD: M=92.6 kDa, M_{w}=124 kDa, Ð=1.33) (Experiment #1), according to some embodiments of the present disclosure.

FIG. 11 illustrates shear viscosity versus time at 200° C. (PHPD: M=92.6 kDa, M_{w}=124 kDa, Ð=1.33) (Experiment #1), according to some embodiments of the present disclosure.

FIG. 12 illustrates an ¹H NMR spectrum (CDCl₃) of isolated 104 kDa PHPD (150 g) (Experiment #2), according to some embodiments of the present disclosure.

FIG. 13 illustrates a GPC trace of PHPD obtained from a neat polymerization (Mₙ=104 kDa, M_{w}=133 kDa, Ð=1.28) (Experiment #2), according to some embodiments of the present disclosure.

FIG. 14 illustrates isolated PHPD obtained from a neat polymerization (Mₙ=104 kDa, M_{w}=133 kDa, Ð=1.28) (Experiment #2), according to some embodiments of the present disclosure.

FIG. 15 illustrates a TGA trace of as synthesized PHPD (Mₙ=104 kDa, Mₙa=133 kDa, Ð =1.28) (Experiment #2), according to some embodiments of the present disclosure.

FIG. 16 illustrates a TGA trace of 4x melted PHPD at a temperature between 120° C. and 150° C. (Mₙ=104 kDa, M_{w}=133 kDa, Ð=1.28) (Experiment. #2), according to some embodiments of the present disclosure.

FIG. 17 illustrates a TGA trace of PHPD (Mₙ=104 kDa, M_{w}=133 kDa, Ð=1.28) (thermal stability at 100° C. under air flow 40.0 mL/min, 1.5% weight loss after 2 hours) (Experiment #2), according to some embodiments of the present disclosure.

FIG. 18 illustrates a TGA trace of PHPD (Mₙ=104 kDa, M_{w}=133 kDa, Ð=1.28) (thermal stability at 200° C. under air flow 40.0 mL/min, 2.8% weight loss after 2 hours) (Experiment #2), according to some embodiments of the present disclosure.

FIG. 19 illustrates a DSC trace of PHPD (Mₙ=104 kDa, M_{w}=133 kDa, Ð=1.28) (Experiment #2), according to some embodiments of the present disclosure.

FIG. 20 illustrates a DMA trace of PHPD (Mₙ=104 kDa, M_{w}=133 kDa, Ð=1.28) (Experiment #2), according to some embodiments of the present disclosure.

FIG. 21 illustrates tensile testing of compression molded PHPD (Mₙ=104 kDa) films with three replicates at a strain rate of 5 mm/min (Experiment #2), according to some embodiments of the present disclosure. Stress, strain, and Young's modulus values for each of the three replicates are tabulated in Table 4B.

FIG. 22 illustrates a strain weep of PHPD (Mₙ=104 kDa, M_{w}=133 kDa, Ð=1.28) (Experiment. #2), according to some embodiments of the present disclosure.

FIG. 23 illustrates shear viscosity versus time of PHPD at 140° C. (Mₙ=104 kDa, M_{w}=133 kDa, Ð=1.28) (Experiment #2), according to some embodiments of the present disclosure.

FIG. 24 illustrates frequency sweep data of PHPD at 140° C. (Mₙ=104 kDa, M_{w}=133 kDa, Ð=1.28) (Experiment #2) to estimate zero shear viscosity, according to some embodiments of the present disclosure.

FIG. 25 illustrates frequency sweep data of PHPD at 160° C. (Mₙ=104 kDa, M_{w}=133 kDa, Ð=1.28) (Experiment #2) to estimate zero shear viscosity, according to some embodiments of the present disclosure.

FIG. 26 illustrates frequency sweep data of PHPD at 170° C. (Mₙ=104 kDa, M_{w}=133 kDa, Ð=1.28) (Experiment #2) to estimate zero shear viscosity, according to some embodiments of the present disclosure.

FIG. 27 illustrates frequency sweep data of PHPD at 200° C. (Mₙ=104 kDa, M_{w}=133 kDa, Ð=1.28) (Experiment #2) to estimate zero shear viscosity, according to some embodiments of the present disclosure.

FIG. 28 illustrates frequency sweep data of PHPD at 140° C. (Mₙ=104 kDa, M_{w}=133 kDa, Ð=1.28) versus injection molding grade low-density polyethylene (LDPE) (Experiment #2), according to some embodiments of the present disclosure.

FIG. 29 illustrates frequency sweep data of PHPD at 140° C. (Mₙ=104 kDa, M_{w}=133 kDa, Ð=1.28) versus film grade LDPE (Experiment #2) and zero shear viscosity, according to some embodiments of the present disclosure.

FIG. 30 illustrates frequency sweep data of PHPD at 150° C. (Mₙ=104 kDa, M_{w}=133 kDa, Ð=1.28) versus film grade LDPE (Experiment #2) and zero shear viscosity, according to some embodiments of the present disclosure.

FIG. 31 illustrates frequency sweep data of PHPD at 190° C. (Mₙ=104 kDa, M_{w}=133 kDa, Ð=1.28) versus film grade LDPE (Experiment #2) and zero shear viscosity, according to some embodiments of the present disclosure.

FIG. 32 illustrates time-temperature superposition (TTS) curves of PHPD at 110° C. (Mₙ=104 kDa, M_{w}=133 kDa, Ð=1.28) (Experiment #2), according to some embodiments of the present disclosure.

FIG. 33 illustrates TTS curves of PHPD at 120° C. (Mₙ=104 kDa, M_{w}=133 kDa, Ð=1.28) (Experiment #2), according to some embodiments of the present disclosure.

FIG. 34 illustrates TTS curves of PHPD at 140° C. (Mₙ=104 kDa, M_{w}=133 kDa, Ð=1.28) (Experiment #2), according to some embodiments of the present disclosure.

FIG. 35 illustrates TTS curves of PHPD at 190° C. (Mₙ=104 kDa, M_{w}=133 kDa, Ð=1.28) (Experiment #2), according to some embodiments of the present disclosure.

FIG. 36 illustrates TTS curves of PHPD at 200° C. (Mₙ=104 kDa, Mₙa=133 kDa, Ð=1.28).

FIG. 37 illustrates an Arrhenius activation energy plot of PHPD at 110° C. (Mₙ=104 kDa, M_{w}=133 kDa, Ð=1.28) (Experiment #2), according to some embodiments of the present disclosure.

FIG. 38 illustrates an Arrhenius activation energy plot of PHPD at 120° C. (Mₙ=104 kDa, M_{w}=133 kDa, Ð=1.28) (Experiment #2), according to some embodiments of the present disclosure.

FIG. 39 illustrates an Arrhenius activation energy plot of PHPD at 140° C. (Mₙ=104 kDa, M_{w}=133 kDa, Ð=1.28) (Experiment #2), according to some embodiments of the present disclosure.

FIG. 40 illustrates an Arrhenius activation energy plot of PHPD at 190° C. (Mₙ=104 kDa, M_{w}=133 kDa, Ð=1.28) (Experiment #2), according to some embodiments of the present disclosure.

FIG. 41 illustrates an Arrhenius activation energy plot of PHPD at 200° C. (Mₙ=104 kDa, M_{w}=133 kDa, Ð=1.28) (Experiment #2), according to some embodiments of the present disclosure.

FIG. 42 illustrates an ¹H NMR (CDCl₃) spectrum of isolated 102 kDa PHPD (172 g) (Experiment #3), according to some embodiments of the present disclosure.

FIG. 43 illustrates a GPC trace of PHPD obtained from the 172 g scale neat polymerization (Mₙ=102 kDa, M_{w}=134 kDa, Ð=1.31) (Experiment #3), according to some embodiments of the present disclosure.

FIG. 44 illustrates PHPD obtained from the 172 g scale neat polymerization (172 g) (Experiment #3), according to some embodiments of the present disclosure.

FIG. 45 illustrates a TGA trace of 4x melted PHPD at a temperature between 100° C. and 120° C. (Mₙ=102 kDa, M_{w}=134 kDa, Ð=1.31) (Experiment #3), according to some embodiments of the present disclosure.

FIG. 46 illustrates a DSC trace of PHPD (Mₙ=102 kDa, M_{w}=134 kDa, Ð=1.31) (Experiment #3), according to some embodiments of the present disclosure.

FIG. 47 illustrates an ¹H NMR (CDCl₃) spectrum of isolated 104 kDa PHPD obtained from the 550 g scale neat polymerization (Experiment #4), according to some embodiments of the present disclosure.

FIG. 48 illustrates a GPC trace of PHPD obtained from the 550 g scale neat polymerization (Mₙ=104 kDa, M_{w}=138 kDa, Ð=1.33) (Experiment #4), according to some embodiments of the present disclosure.

FIG. 49 illustrates PHPD obtained from the 550 g scale neat polymerization(Experiment #4), according to some embodiments of the present disclosure.

FIG. 50 illustrates a TGA trace of PHPD (Mₙ=104 kDa, M_{w}=138 kDa, Ð=1.33) (Experiment #4), according to some embodiments of the present disclosure.

FIG. 51 illustrates a DSC trace of PHPD (Mₙ=104 kDa, M_{w}=138 kDa, Ð=1.33) (Experiment #4), according to some embodiments of the present disclosure.

FIG. 52 illustrates a blown film of PHPD (Mₙ=104 kDa, M_{w}=138 kDa, Ð=1.33) versus film grade LDPE (Experiment #4), according to some embodiments of the present disclosure.

FIG. 53 illustrates an ¹H NMR (CDCl₃) spectrum of isolated 120 kDa PHPD (111 g) (Experiment #5), according to some embodiments of the present disclosure.

FIG. 54 illustrates a GPC trace of PHPD obtained from the 111 g scale neat polymerization (Mₙ=120 kDa, M_{w}=171 kDa, Ð=1.42) (Experiment #5), according to some embodiments of the present disclosure.

FIG. 55 illustrates isolated PHPD obtained from the 111 g scale neat polymerization (Mₙ=120 kDa, M_{w}=171 kDa, Ð=1.42) (Experiment #5), according to some embodiments of the present disclosure.

FIG. 56 illustrates a TGA trace of PHPD (Mₙ=120 kDa, M_{w}=171 kDa, Ð=1.42) (Experiment #5), according to some embodiments of the present disclosure.

FIG. 57 illustrates a DSC trace of PHPD (Mₙ=120 kDa, M_{w}=171 kDa, Ð=1.42) (Experiment #5), according to some embodiments of the present disclosure.

FIG. 58A illustrates a melt strength of PHPD at 145° C. (Mₙ=104 kDa, M_{w}=133 kDa, Ð =1.28), according to some embodiments of the present disclosure.

FIG. 58B illustrates a melt strength of PHPD at 145° C. (Mₙ=104 kDa, M_{w}=133 kDa, Ð =1.28), according to some embodiments of the present disclosure.

FIG. 58C illustrates a melt strength of PHPD at 155° C. (Mₙ=104 kDa, M_{w}=133 kDa, Ð =1.28), according to some embodiments of the present disclosure.

FIG. 58D illustrates a melt strength of PHPD at 155° C. (Mₙ=104 kDa, M_{w}=133 kDa, Ð =1.28), according to some embodiments of the present disclosure.

FIG. 58E illustrates a melt strength of PHPD at 165° C. (Mₙ=104 kDa, M_{w}=133 kDa, Ð =1.28), according to some embodiments of the present disclosure.

FIG. 58F illustrates a melt strength of PHPD at 165° C. (Mₙ=104 kDa, M_{w}=133 kDa, Ð =1.28), according to some embodiments of the present disclosure.

FIG. 58G illustrates a melt strength of PHPD at 175° C. (Mₙ=104 kDa, M_{w}=133 kDa, Ð =1.28), according to some embodiments of the present disclosure.

FIG. 58H illustrates a melt strength of PHPD at 175° C. (Mₙ=104 kDa, M_{w}=133 kDa, Ð =1.28), according to some embodiments of the present disclosure.

FIG. 581 illustrates a melt strength of PHPD at 190° C. (Mₙ=104 kDa, M_{w}=133 kDa, Ð=1.28), according to some embodiments of the present disclosure.

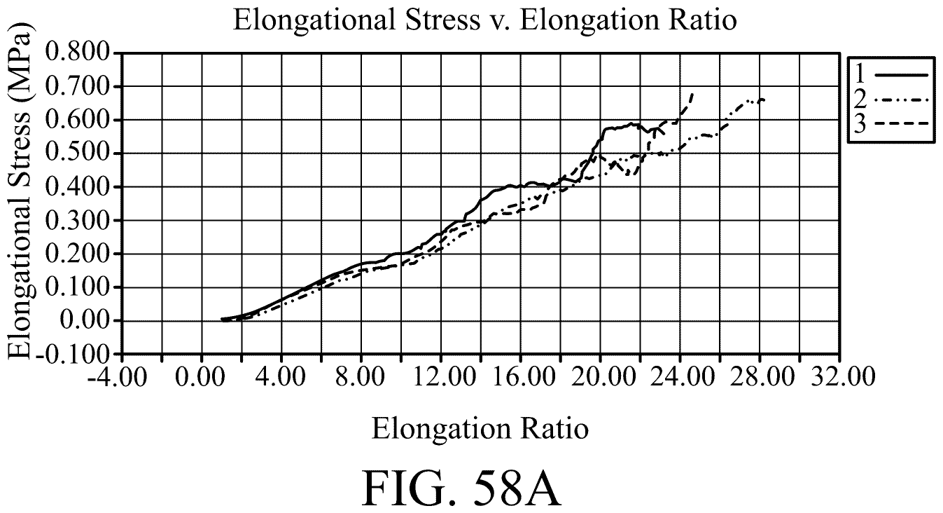

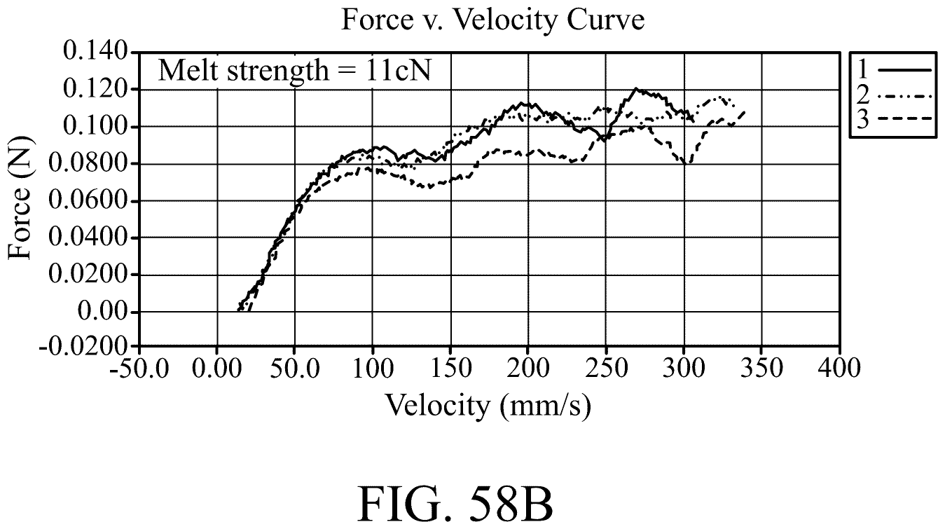

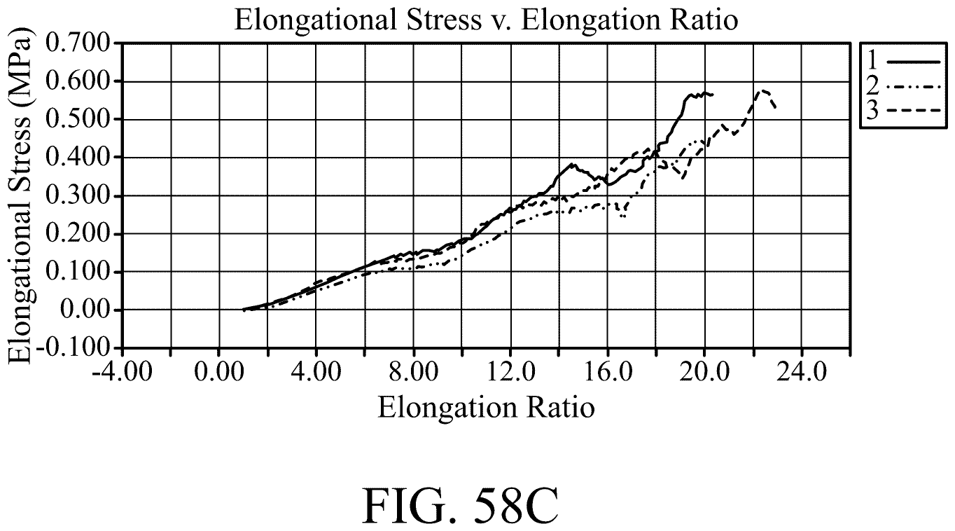

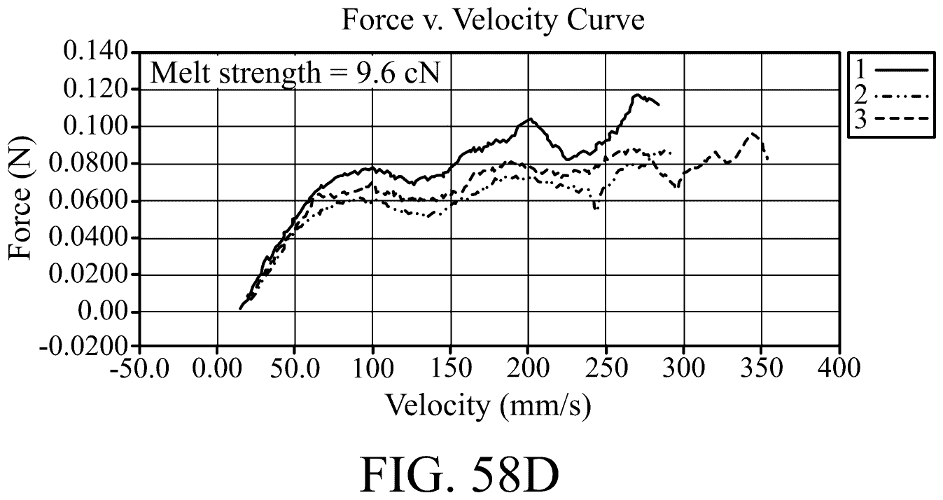

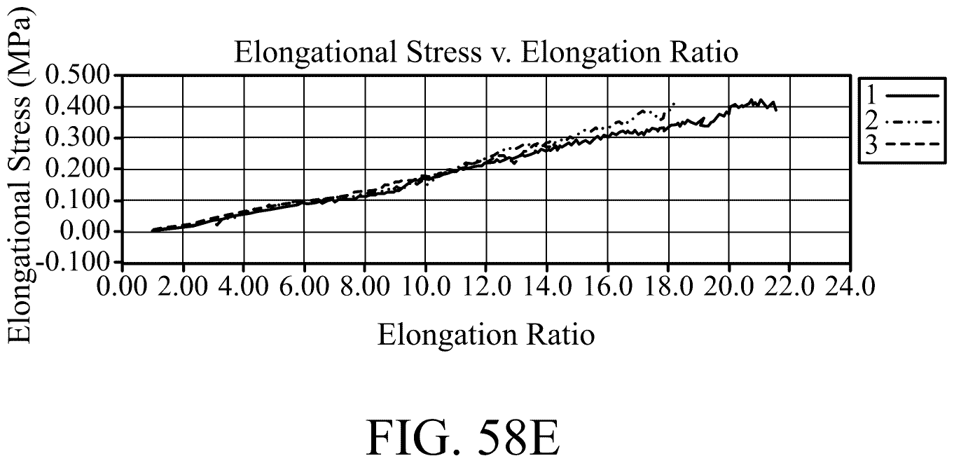

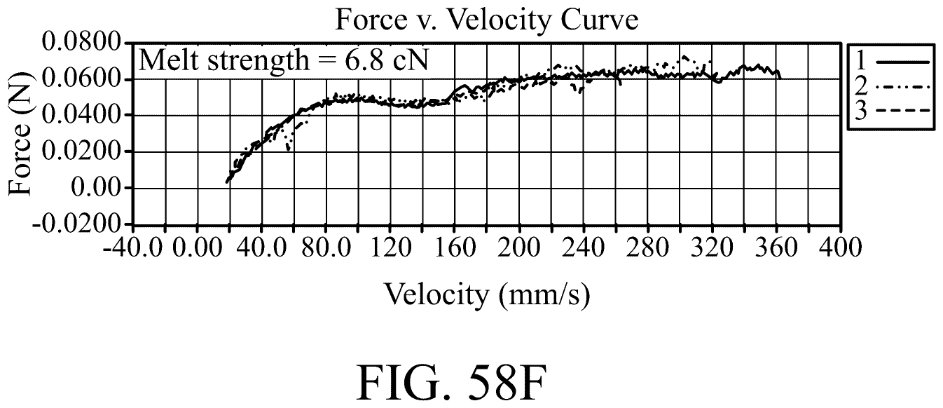

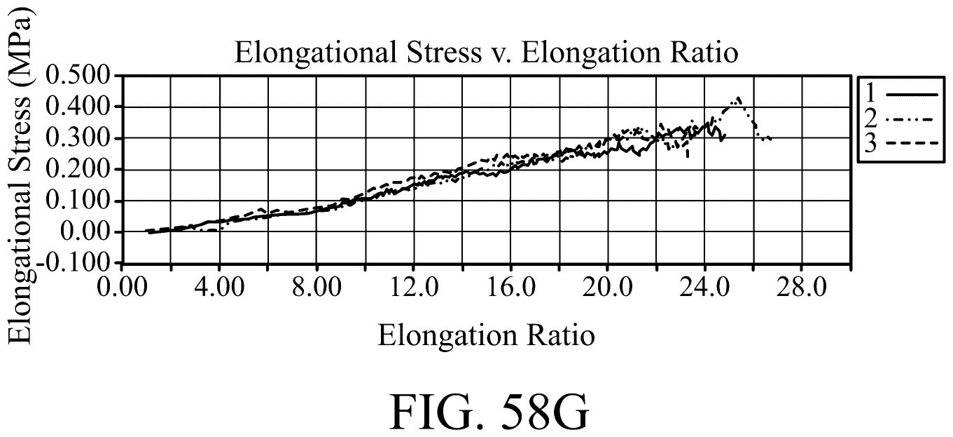

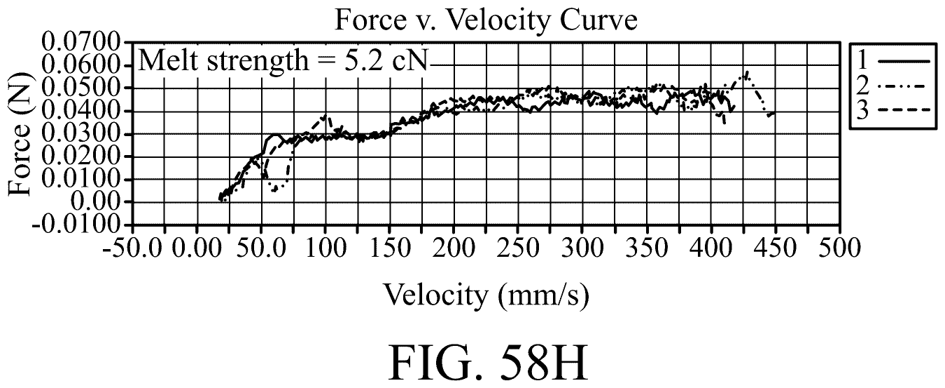

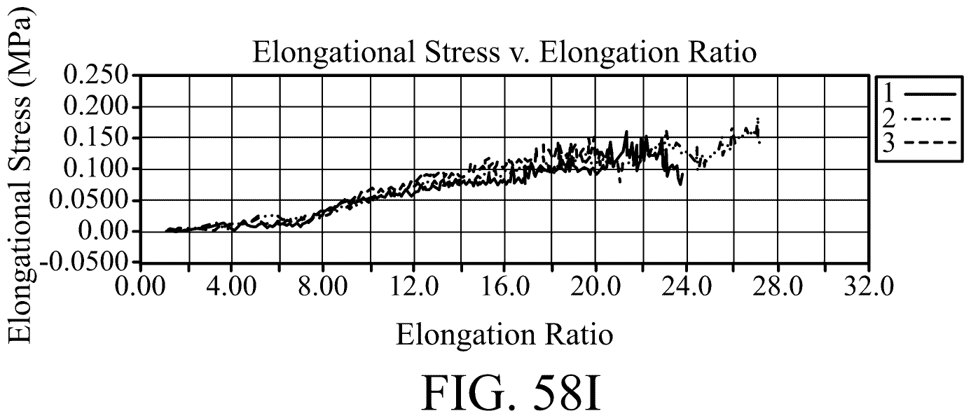

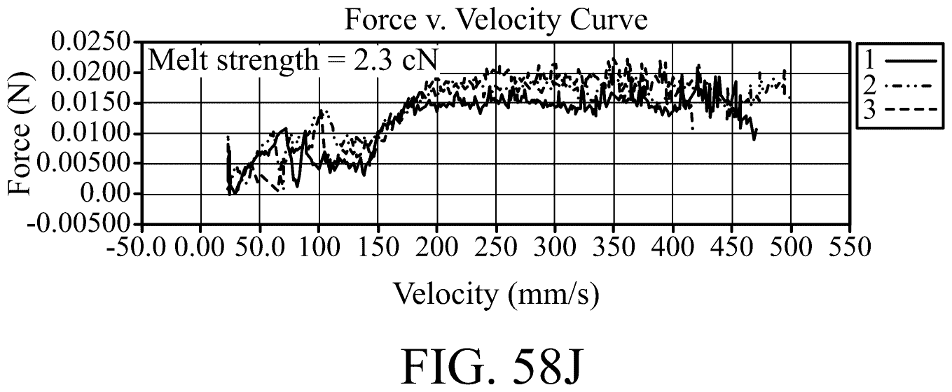

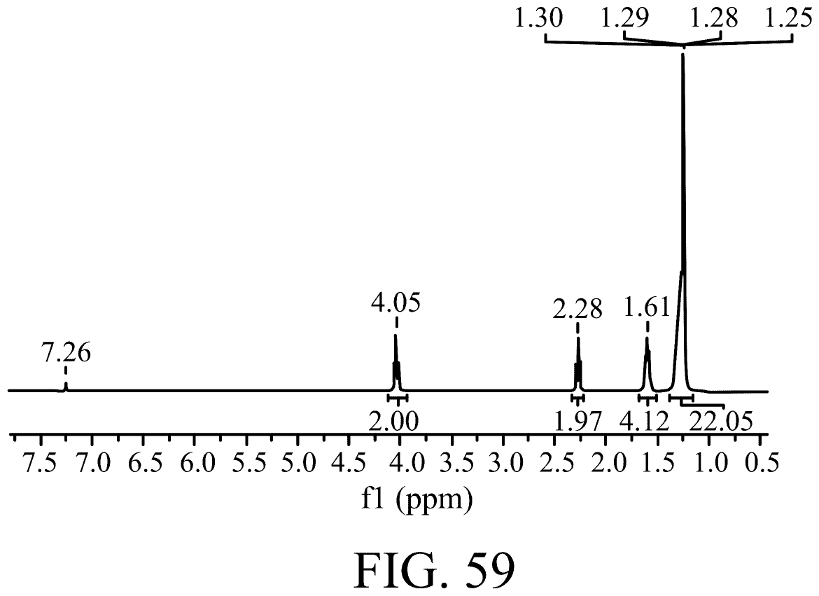

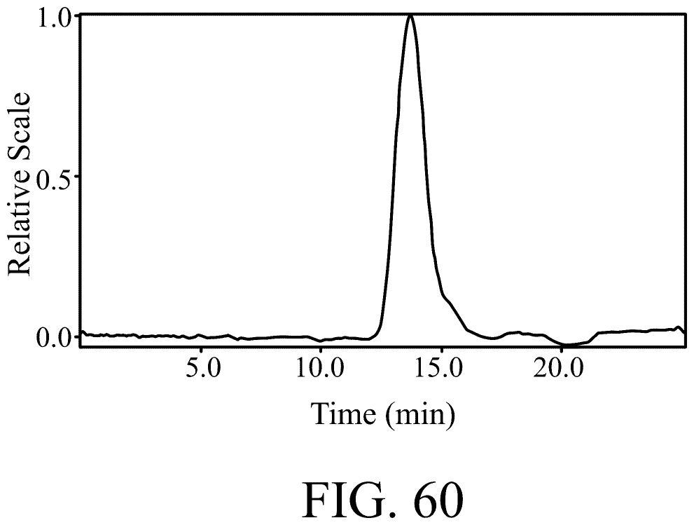

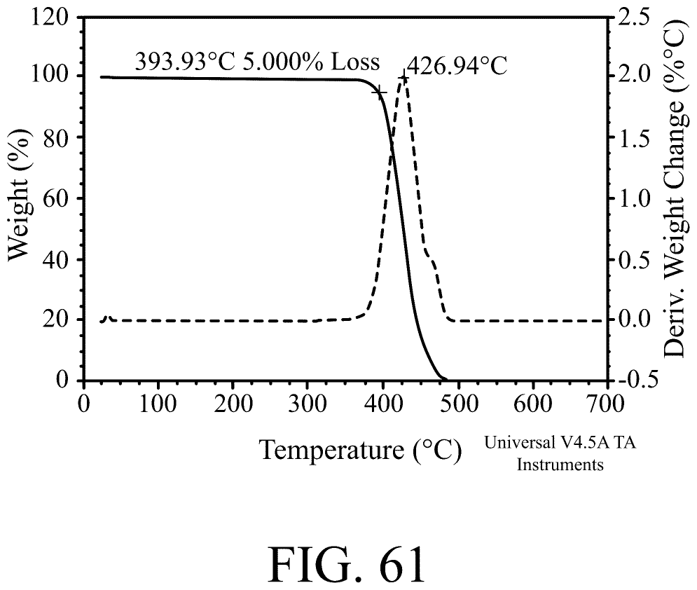

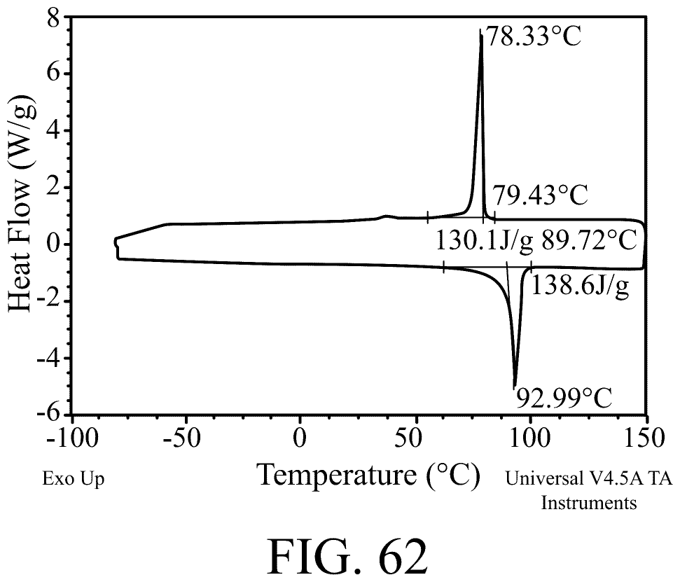

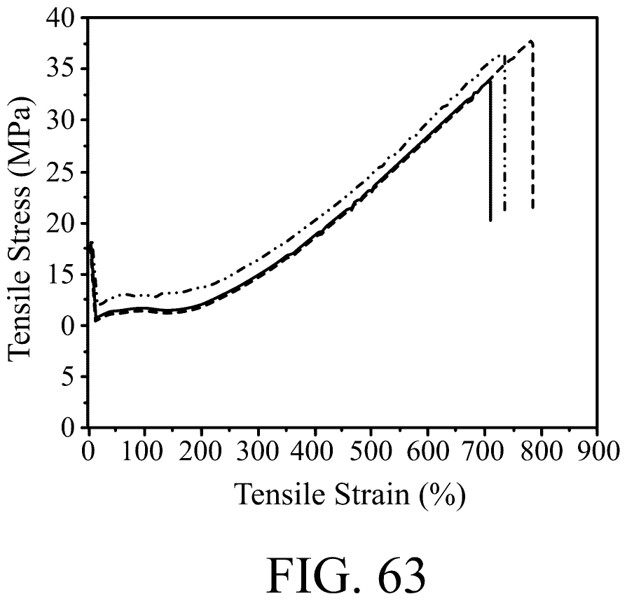

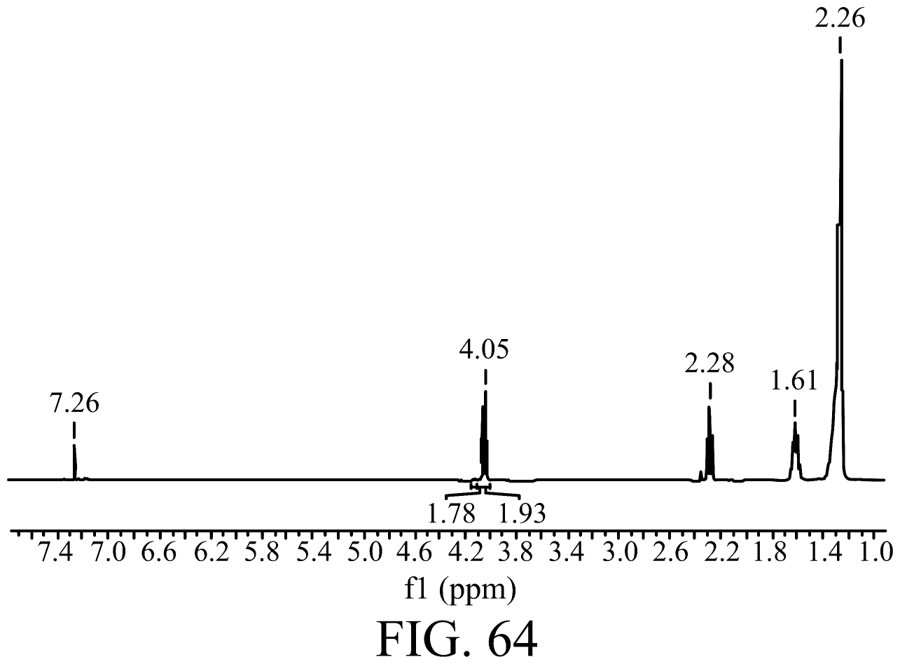

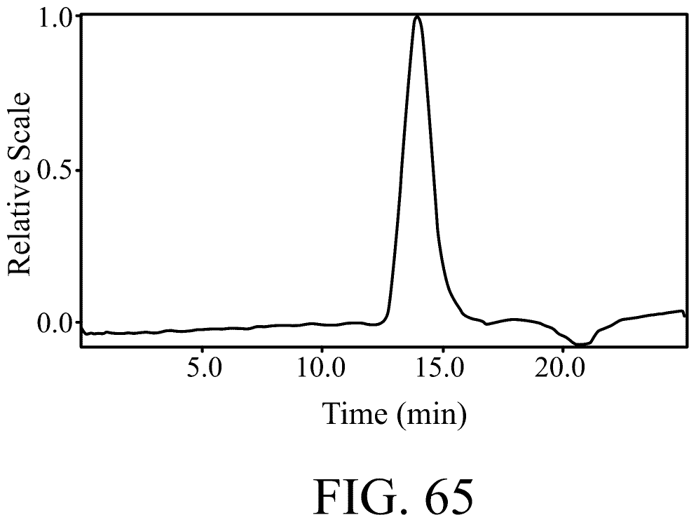

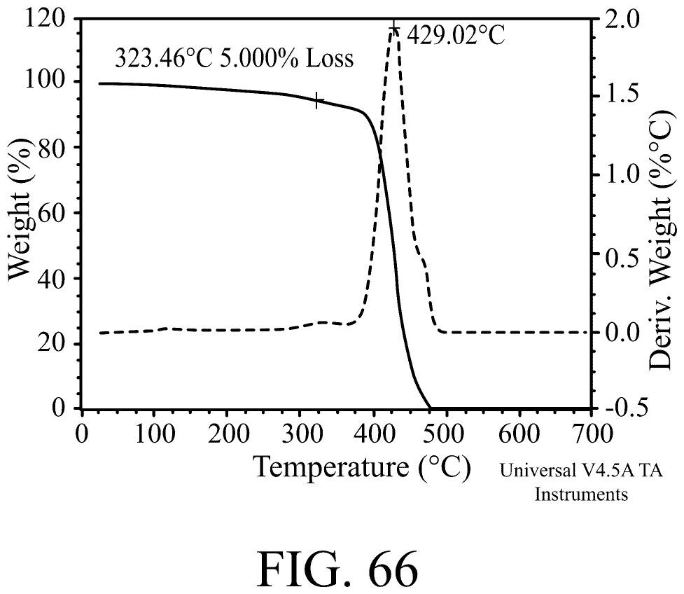

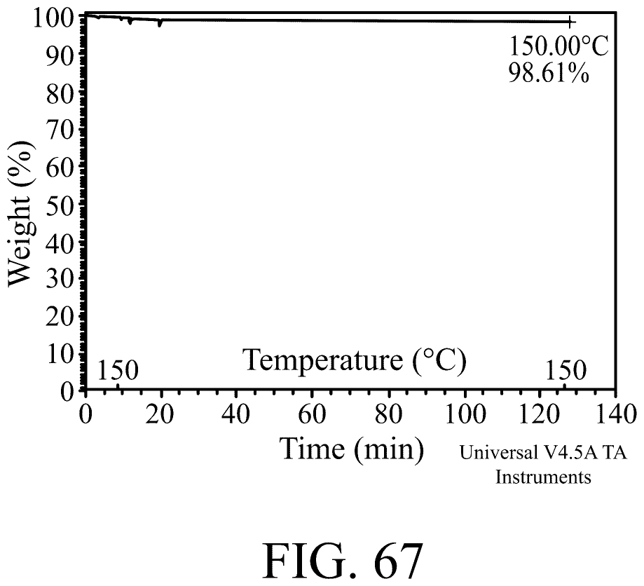

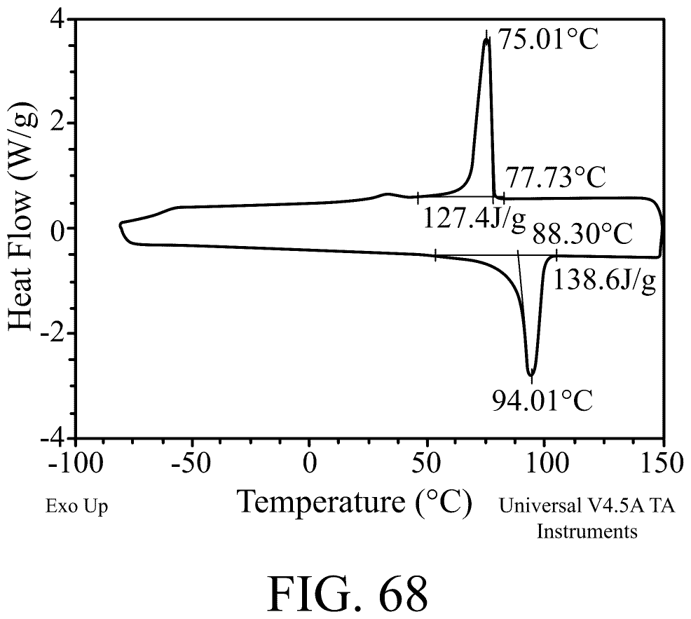

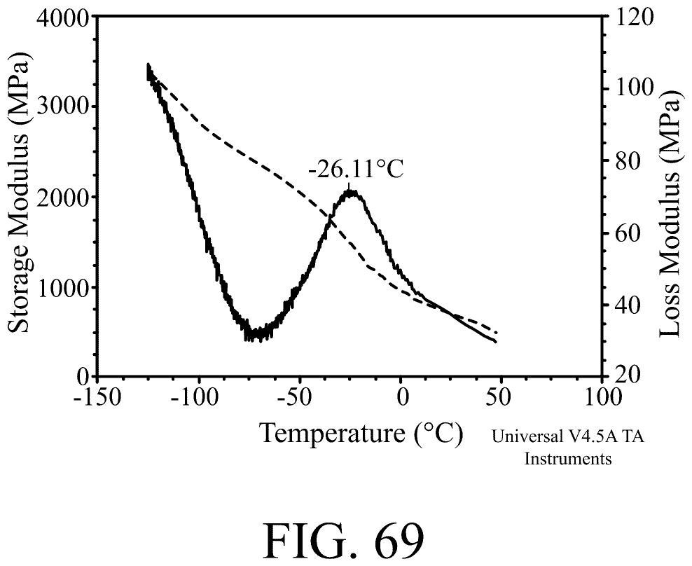

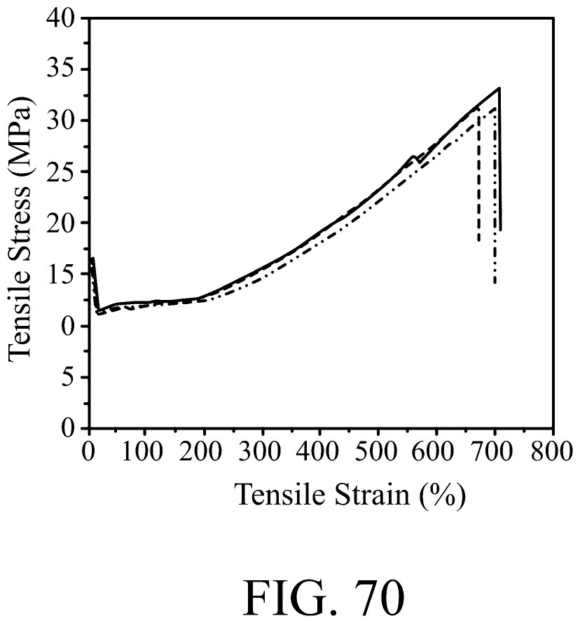

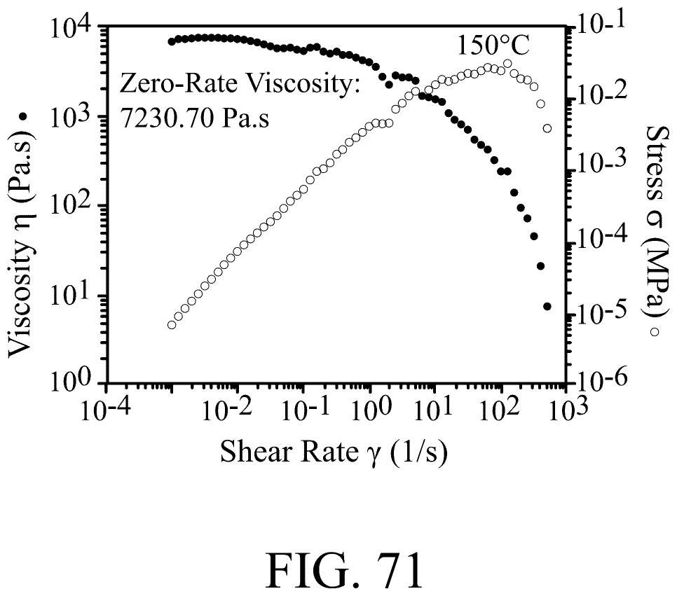

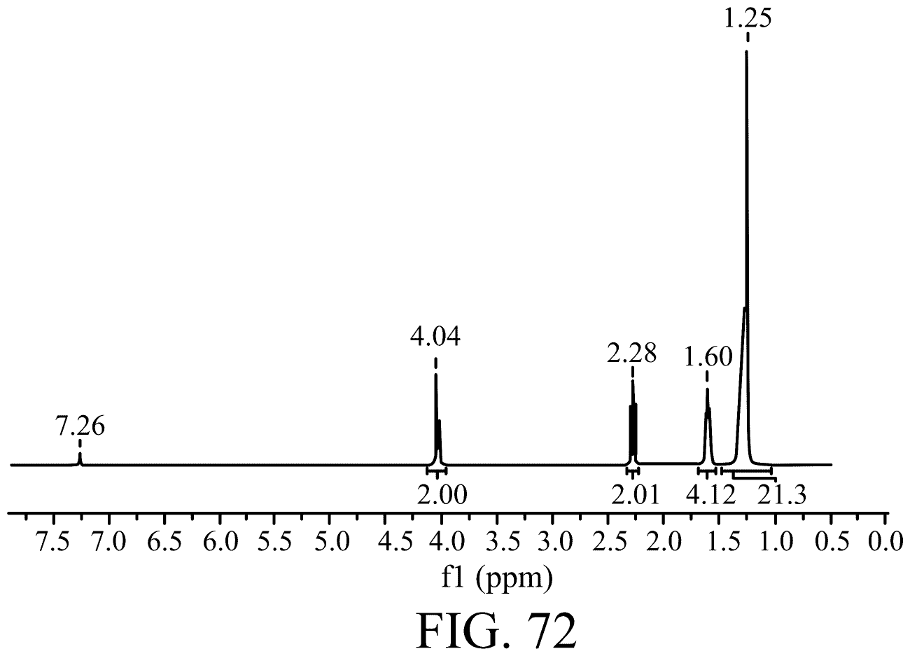

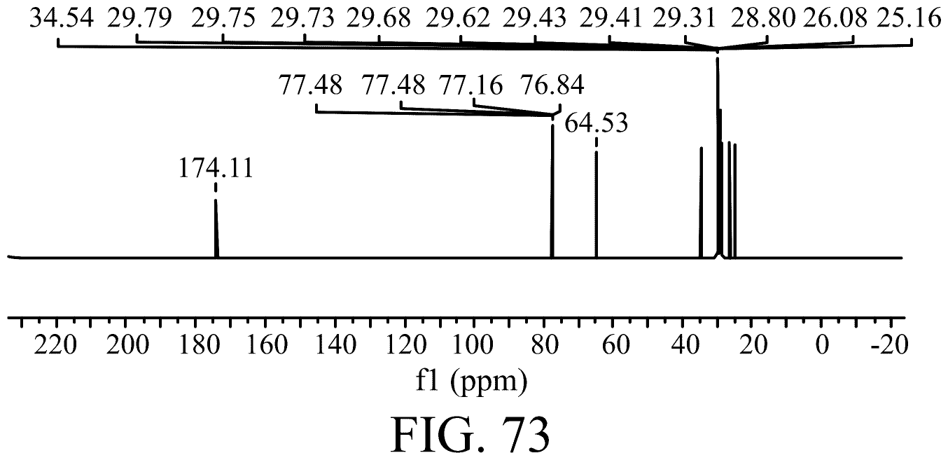

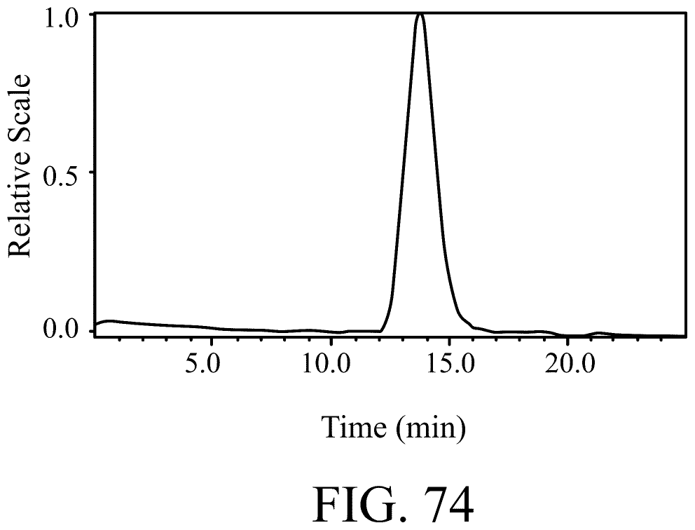

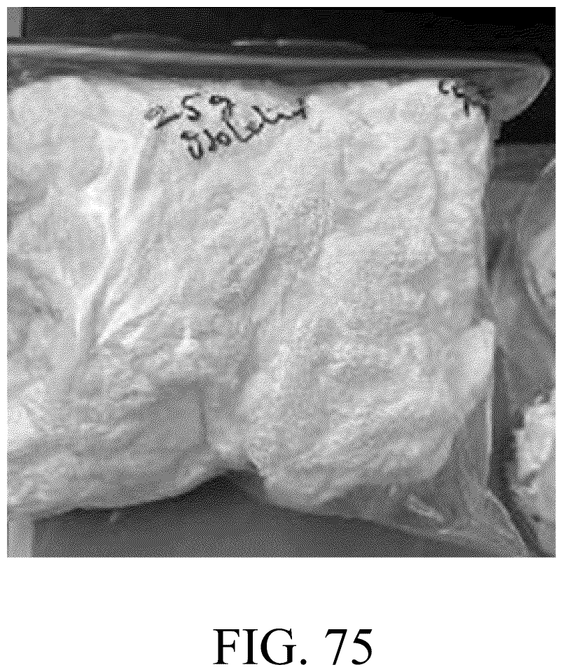

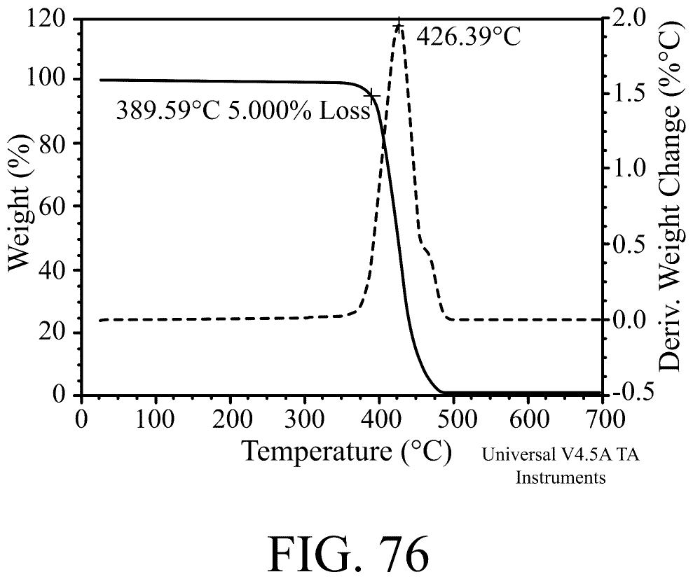

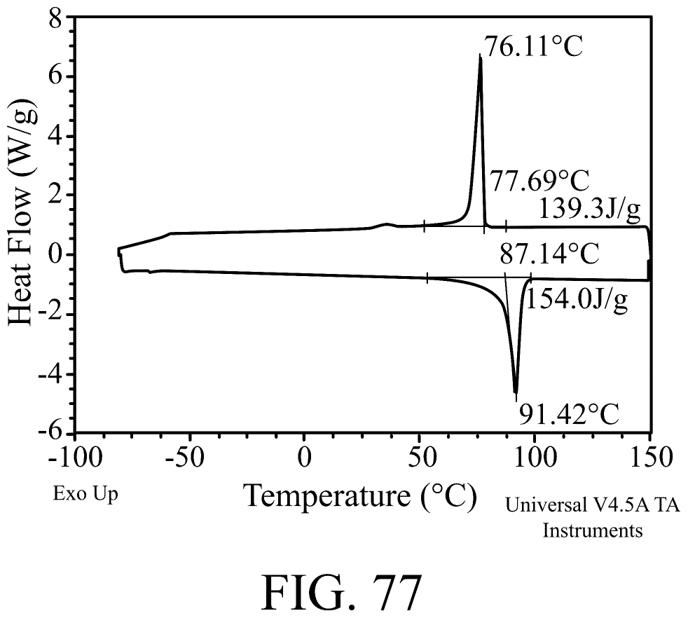

FIG. 58J illustrates a melt strength of PHPD at 190° C. (Mₙ=104 kDa, M_{w}=133 kDa, Ð=1.28), according to some embodiments of the present disclosure.

FIG. 59 illustrates am ¹H NMR (CDCl₃) spectrum of purified 142 kDa PHHD (14.7 g) (Experiment #6B), according to some embodiments of the present disclosure.

FIG. 60 illustrates a GPC trace of purified PHHD obtained from the 14.7 g scale neat polymerization (Mₙ=142 kDa, M_{w}=193 kDa, Ð=1.36) (Experiment #6B), according to some embodiments of the present disclosure.

FIG. 61 illustrates a TGA trace of purified PHHD obtained from the 14.7 g scale neat polymerization (Mₙ=142 kDa, M_{w}=193 kDa, Ð=1.36) (Experiment #6B), according to some embodiments of the present disclosure.

FIG. 62 illustrates a DSC trace of purified PHHD obtained from the 14.7 g scale neat polymerization (Mₙ=142 kDa, M_{w}=193 kDa, Ð=1.36) (Experiment #6B), according to some embodiments of the present disclosure.

FIG. 63 illustrates tensile testing results (three replicates) of purified PHHD obtained from the 14.7 g scale neat polymerization (Mₙ=142 kDa, M_{w}=193 kDa, Ð=1.36) (Experiment #6B) at a strain rate of 5 mm/min, according to some embodiments of the present disclosure.

FIG. 64 illustrates an ¹H NMR (CDCl₃) spectrum of unpurified PHHD obtained from the 15.0 g scale neat polymerization (Mₙ=149 kDa, M_{w}=164 kDa, Ð=1.09) (Experiment #6A), according to some embodiments of the present disclosure.

FIG. 65 illustrates a GPC trace of unpurified PHHD obtained from the 15.0 g scale neat polymerization (Mₙ=149 kDa, M_{w}=164 kDa, Ð=1.09) (Experiment #6A), according to some embodiments of the present disclosure.

FIGS. 66 and 67 illustrate TGA traces of unpurified PHHD obtained from the 15.0 g scale neat polymerization (Mₙ=149 kDa, M_{w}=164 kDa, Ð=1.09) (Experiment #6A), according to some embodiments of the present disclosure.

FIG. 68 illustrates a DSC trace of unpurified PHHD obtained from the 15.0 g scale neat polymerization (Mₙ=149 kDa, M_{w}=164 kDa, Ð=1.09) (Experiment #6A), according to some embodiments of the present disclosure.

FIG. 69 illustrates a DMA trace of unpurified PHHD obtained from the 15.0 g scale neat polymerization (Mₙ=149 kDa, M_{w}=164 kDa, Ð=1.09) (Experiment #6A), according to some embodiments of the present disclosure.

FIG. 70 illustrates tensile testing results (three replicates) of unpurified PHHD obtained from the 15.0 g scale neat polymerization (Mₙ=149 kDa, M_{w}=164 kDa, Ð=1.09) (Experiment #6A) at a strain rate of 5 mm/min, according to some embodiments of the present disclosure.

FIG. 71 illustrates shear viscosity versus time at 160° C. of unpurified PHHD obtained from the 15.0 g scale neat polymerization (Mₙ=149 kDa, M_{w}=164 kDa, Ð=1.09) (Experiment #6A), according to some embodiments of the present disclosure.

FIGS. 72 and 73 illustrate ¹H NMR (CDCl₃) spectra of isolated 61 kDa PHPD-co-PHHD (Experiment #6C), according to some embodiments of the present disclosure.

FIG. 74 illustrates a GPC trace of isolated 61 kDa PHPD-co-PHHD (Experiment #6C), according to some embodiments of the present disclosure.

FIG. 75 illustrates a photograph of isolated 61 kDa PHPD-co-PHHD (Experiment #6C), according to some embodiments of the present disclosure.

FIG. 76 illustrates a TGA trace of isolated 61 kDa PHPD-co-PHHD (Experiment #6C), according to some embodiments of the present disclosure.

FIG. 77 illustrates a DSC trace of isolated 61 kDa PHPD-co-PHHD (Experiment #6C), according to some embodiments of the present disclosure.

### REFERENCE NUMERALS

100. . . . . . . . . . . . . . . . . . . . . . . . . . . . . . . . . . . . . . . . . . . . . . . . . .method
105. . . . . . . . . . . . . . . . . . . . . . . . . . . . . . . . . . . . . . . . . . . . . . . . ..macrolactones
110. . . . . . . . . . . . . . . . . . . . . . . . . . . . . . . . . . . . . . . . . . . . . . . . ..melting
115. . . . . . . . . . . . . . . . . . . . . . . . . . . . . . . . . . . . . . . . . . . . . . . . ..liquid macrolactone
123. . . . . . . . . . . . . . . . . . . . . . . . . . . . . . . . . . . . . . . . . . . . . . . . ..precatalyst
125. . . . . . . . . . . . . . . . . . . . . . . . . . . . . . . . . . . . . . . . . . . . . . . . ..intiator
130. . . . . . . . . . . . . . . . . . . . . . . . . . . . . . . . . . . . . . . . . . . . . . . . ..combining
137. . . . . . . . . . . . . . . . . . . . . . . . . . . . . . . . . . . . . . . . . . . . . . . . ..first solution
140. . . . . . . . . . . . . . . . . . . . . . . . . . . . . . . . . . . . . . . . . . . . . . . . ..treating
145. . . . . . . . . . . . . . . . . . . . . . . . . . . . . . . . . . . . . . . . . . . . . . . . ..volatile components
147. . . . . . . . . . . . . . . . . . . . . . . . . . . . . . . . . . . . . . . . . . . . . . . . ..catalyst
150. . . . . . . . . . . . . . . . . . . . . . . . . . . . . . . . . . . . . . . . . . . . . . . . ..adding
155. . . . . . . . . . . . . . . . . . . . . . . . . . . . . . . . . . . . . . . . . . . . . . . . ..solvent
157. . . . . . . . . . . . . . . . . . . . . . . . . . . . . . . . . . . . . . . . . . . . . . . . ..second solution
160. . . . . . . . . . . . . . . . . . . . . . . . . . . . . . . . . . . . . . . . . . . . . . . . ..polymerizing
165. . . . . . . . . . . . . . . . . . . . . . . . . . . . . . . . . . . . . . . . . . . . . . . . ..polymacrolactone

### DETAILED DESCRIPTION

The embodiments described herein should not necessarily be construed as limited to addressing any of the particular problems or deficiencies discussed herein. References in the specification to “one embodiment”, “an embodiment”, “an example embodiment”, “some embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

As used herein the term “substantially” is used to indicate that exact values are not necessarily attainable. By way of example, one of ordinary skill in the art will understand that in some chemical reactions 100% conversion of a reactant is possible, yet unlikely. Most of a reactant may be converted to a product and conversion of the reactant may asymptotically approach 100% conversion. So, although from a practical perspective 100% of the reactant is converted, from a technical perspective, a small and sometimes difficult to define amount remains. For this example of a chemical reactant, that amount may be relatively easily defined by the detection limits of the instrument used to test for it. However, in many cases, this amount may not be easily defined, hence the use of the term “substantially”. In some embodiments of the present invention, the term “substantially” is defined as approaching a specific numeric value or target to within 20%, 15%, 10%, 5%, or within 1% of the value or target. In further embodiments of the present invention, the term “substantially” is defined as approaching a specific numeric value or target to within 1%, 0.9%, 0.8%, 0.7%, 0.6%, 0.5%, 0.4%, 0.3%, 0.2%, or 0.1% of the value or target.

As used herein, the term “about” is used to indicate that exact values are not necessarily attainable. Therefore, the term “about” is used to indicate this uncertainty limit. In some embodiments of the present invention, the term “about” is used to indicate an uncertainty limit of less than or equal to ±20%, ±15%, ±10%, ±5%, or ±1% of a specific numeric value or target. In some embodiments of the present invention, the term “about” is used to indicate an uncertainty limit of less than or equal to ±1%, ±0.9%, ±0.8%, ±0.7%, ±0.6%, ±0.5%, ±0.4%, ±0.3%, ±0.2%, or ±0.1% of a specific numeric value or target.

The present disclosure relates to, among other things, a solvent-free (i.e., neat, bulk) polymerization of bioderived macrolactones (e.g., 15-hydroxypentadecanoate, 16-hydroxyhexadeconoate) to produce polymacrolactones (e.g., poly-15-hydroxypentadecanoate (PHPD), poly-16-hydroxyhexadecanoate (PHHD)). Further, the present disclosure describes how such polymacrolactones may be formulated to produce materials that may be utilized in blown film processing systems to produce thin films of polymacrolactones to be used for, among other things, packaging materials. Thus, the materials, methods, and systems described herein may be utilized to replace incumbent petroleum-based polymers such as polyethylene (PE) and/or polypropylene (PP).

Structure I illustrates a polymer, a polymacrolactone, according to some embodiments of the present disclosure.

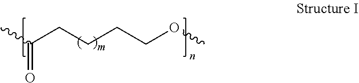

m may be between 11 and 15 or between 8 and 2. n may be between 1 and 5,000, and [symbol] is a covalent bond. A polymer like that represented by Structure I may be synthesized by polymerizing a cyclic molecule, e.g., a macrolactone, like that illustrated by Structure II:

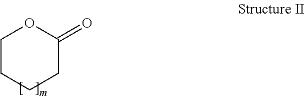

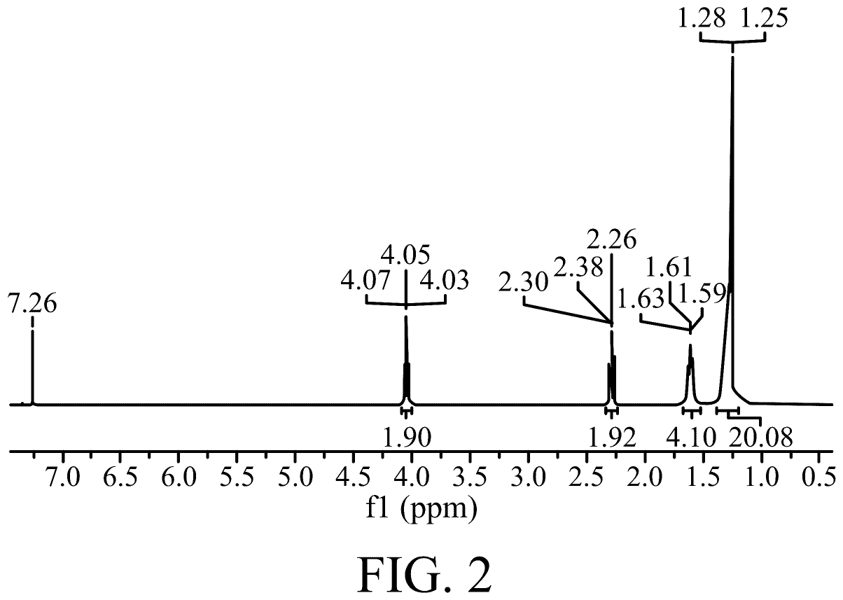

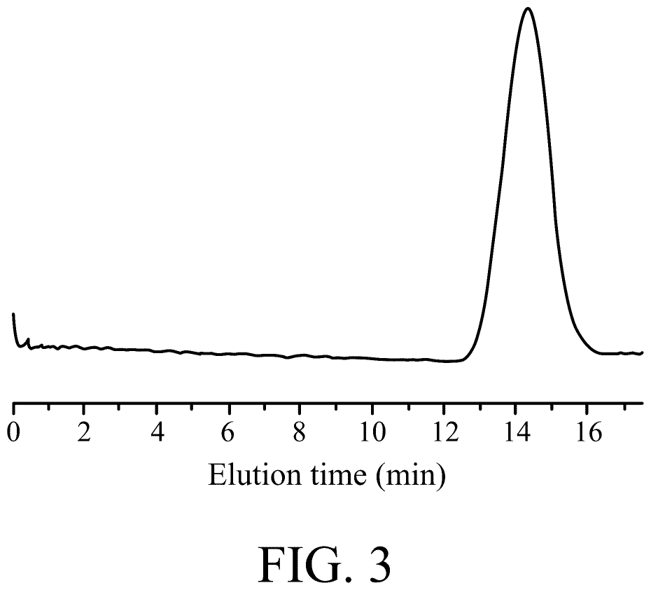

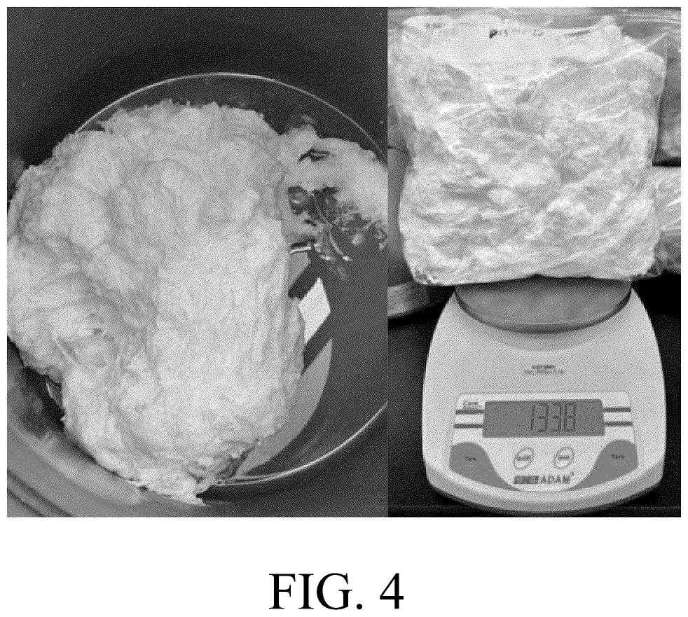

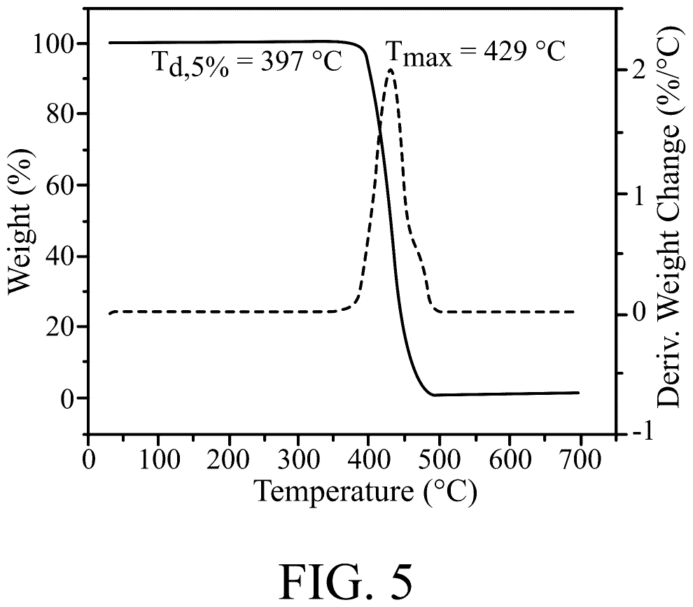

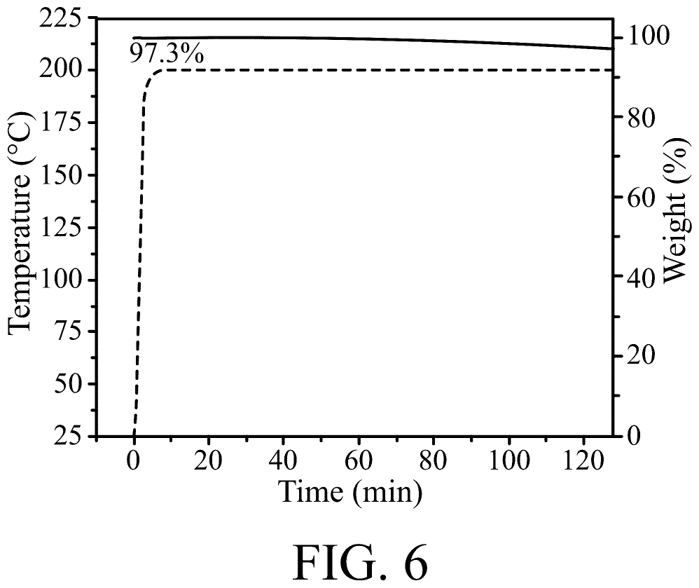

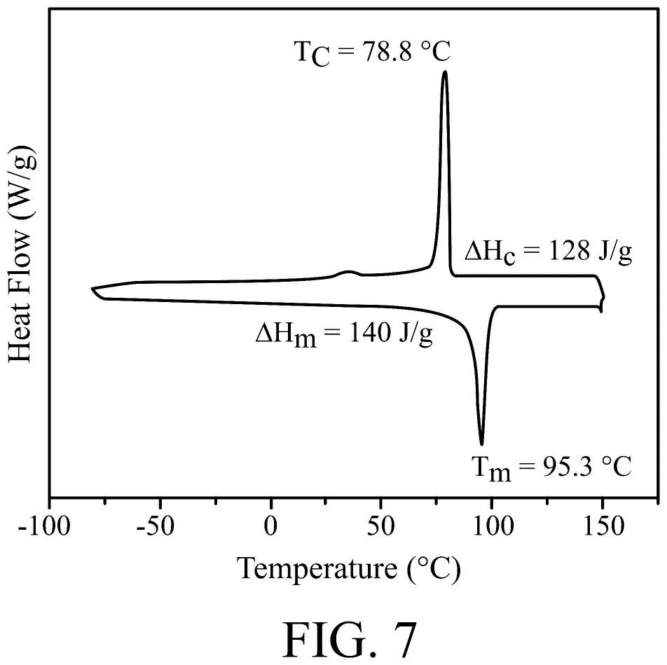

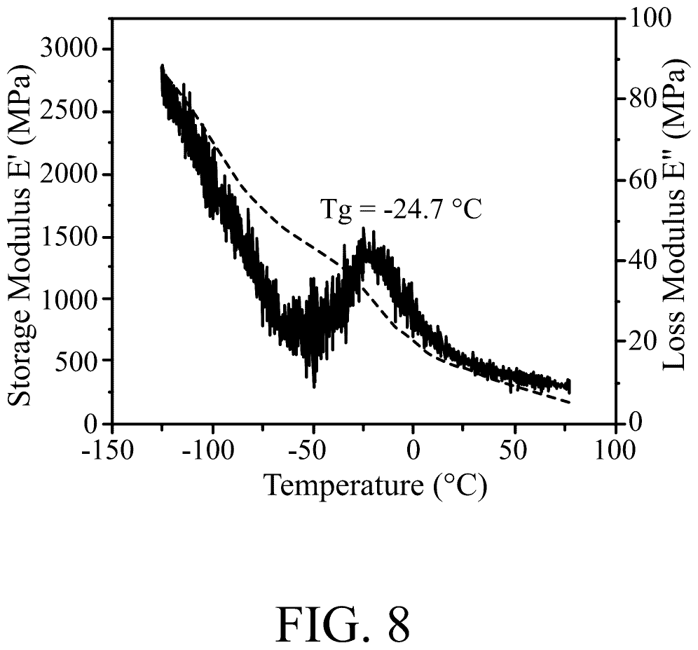

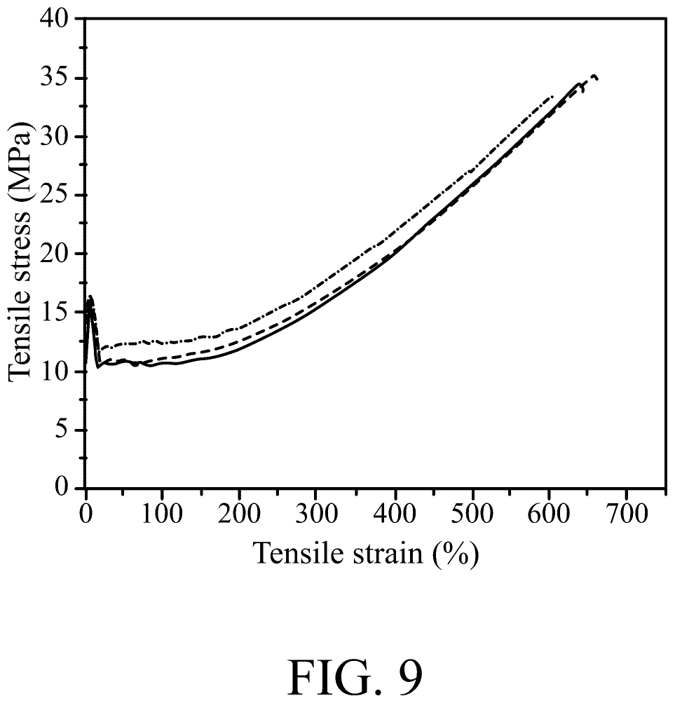

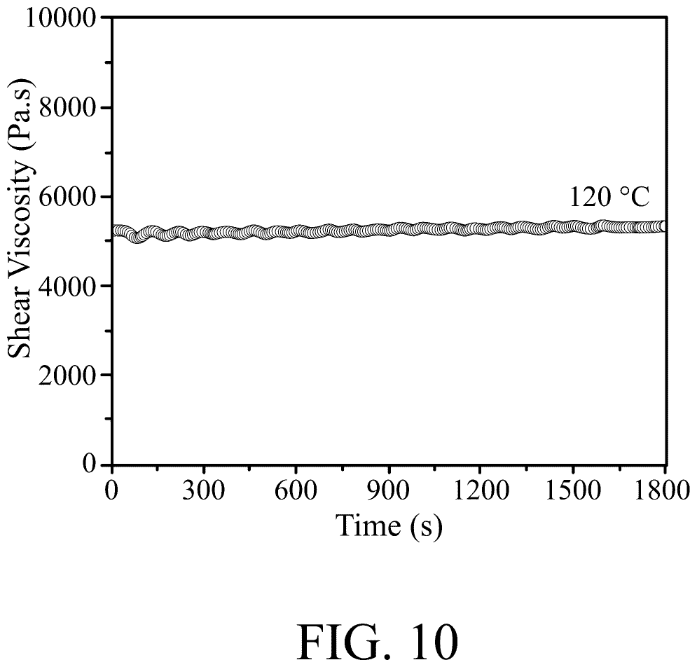

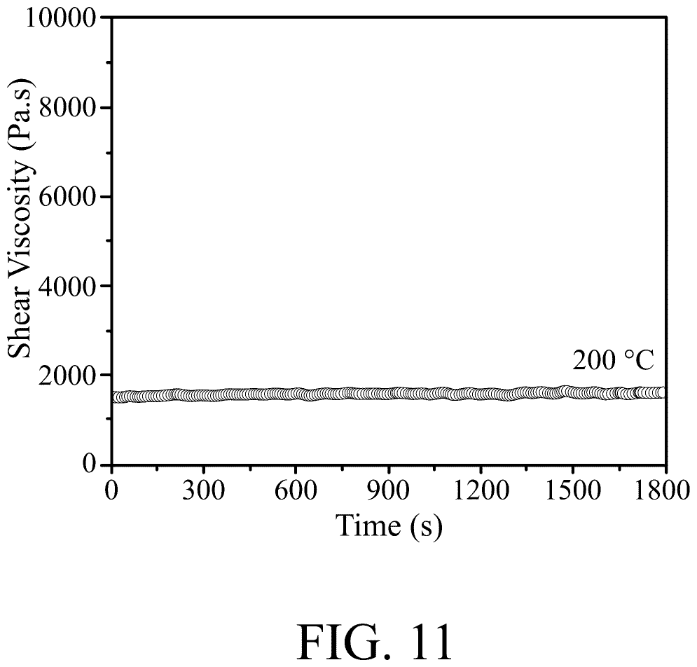

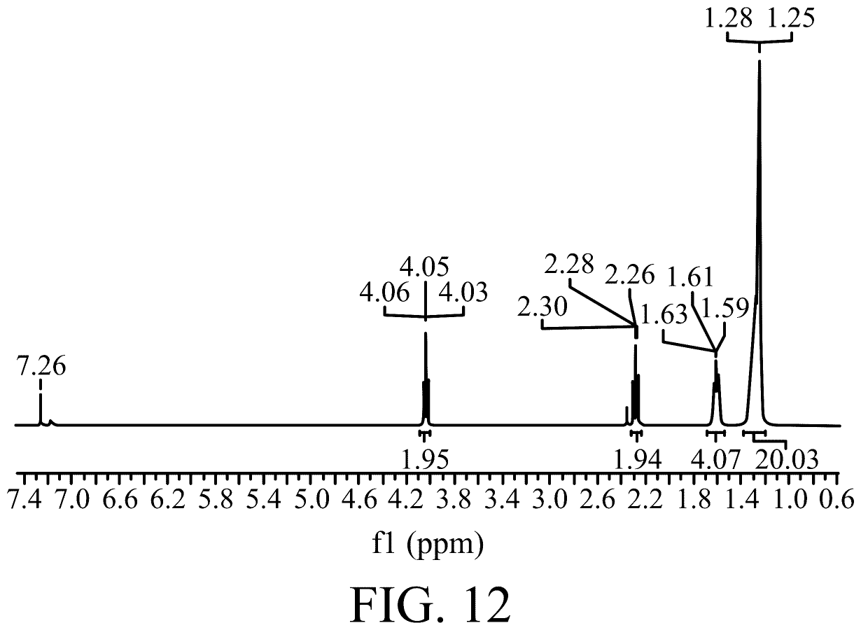

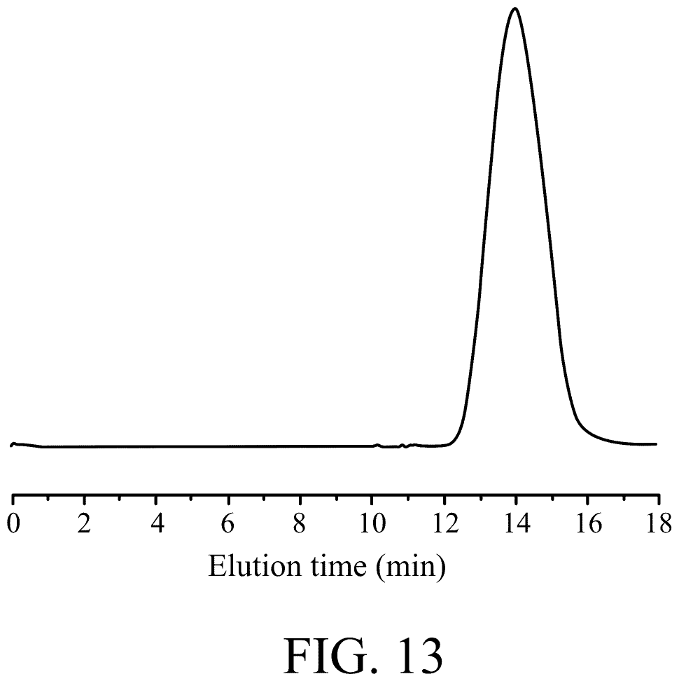

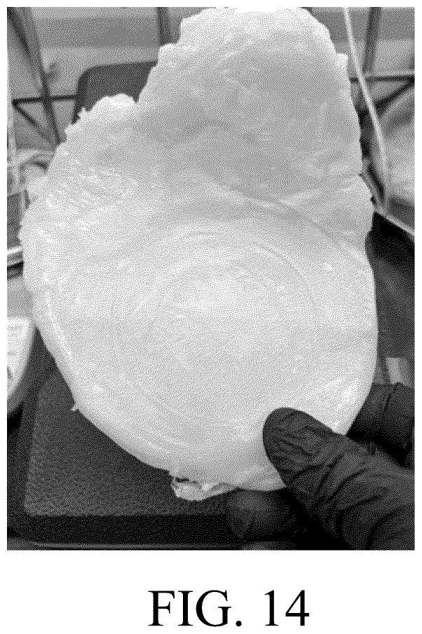

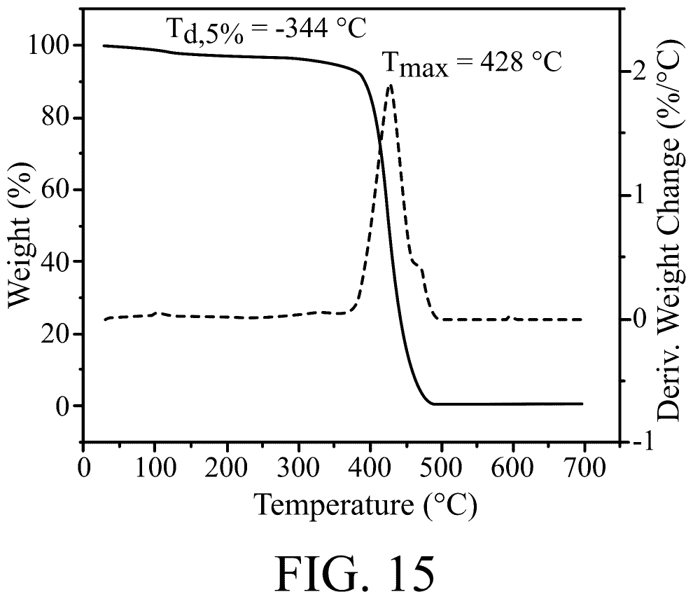

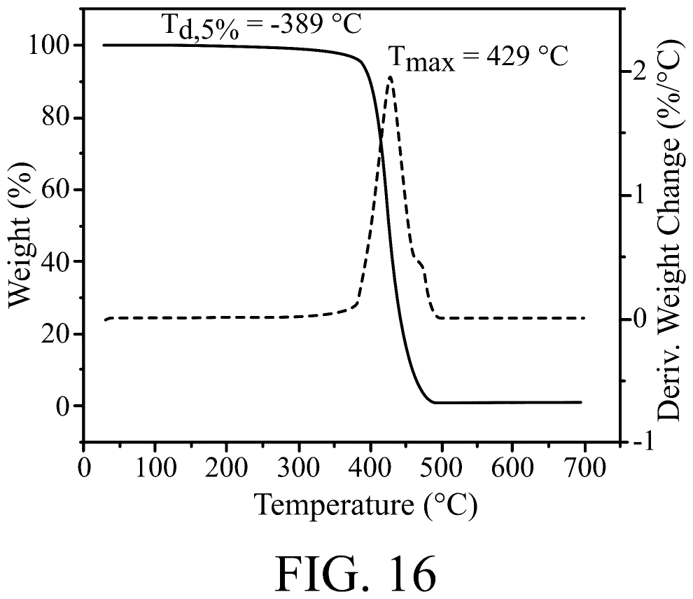

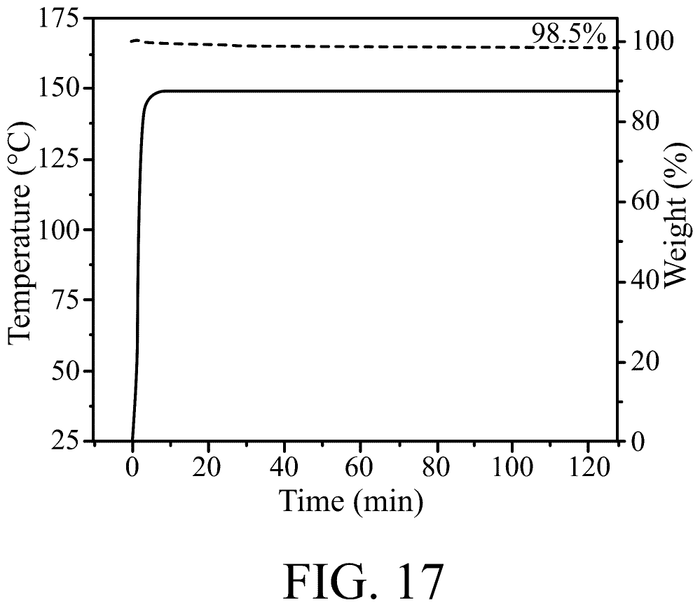

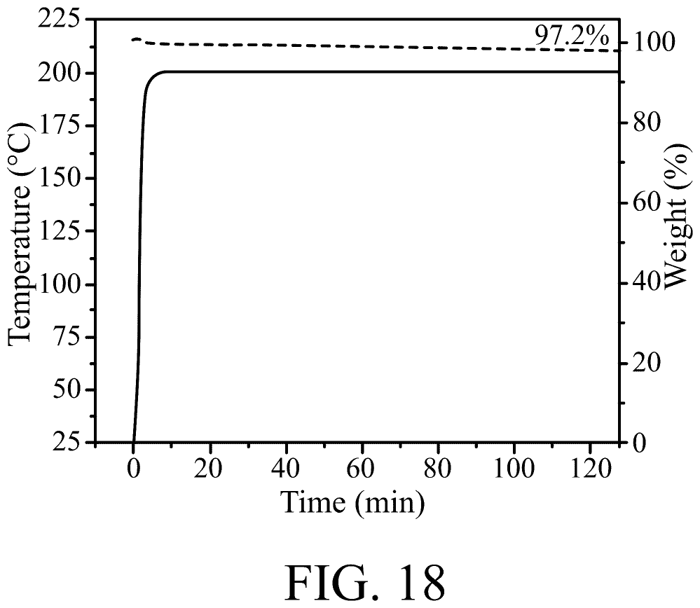

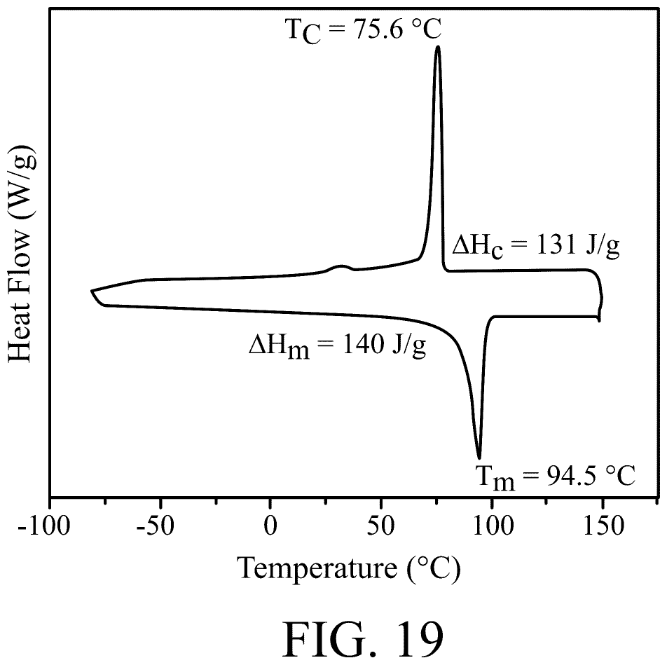

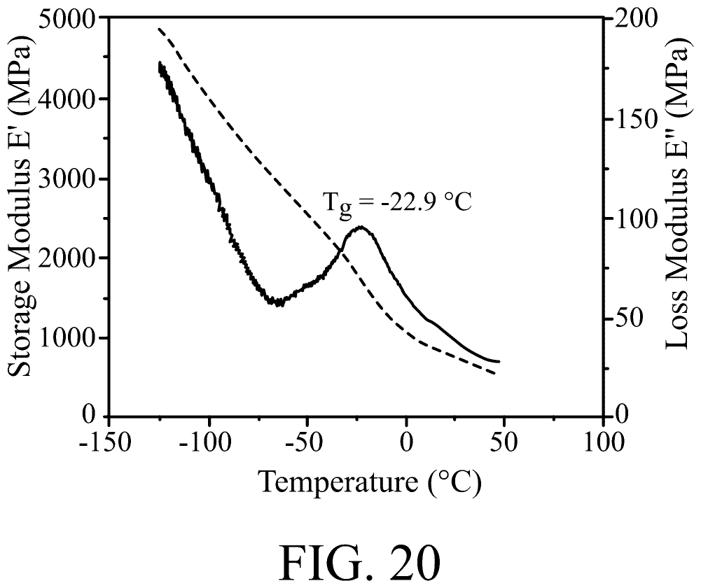

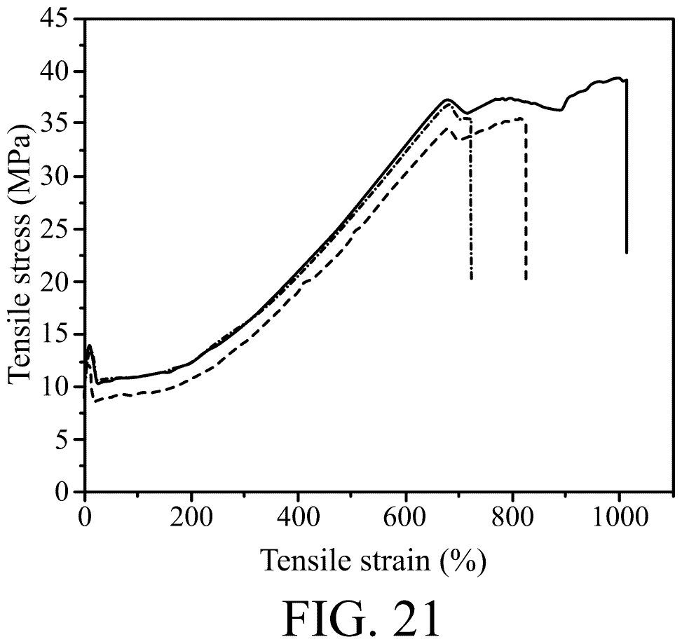

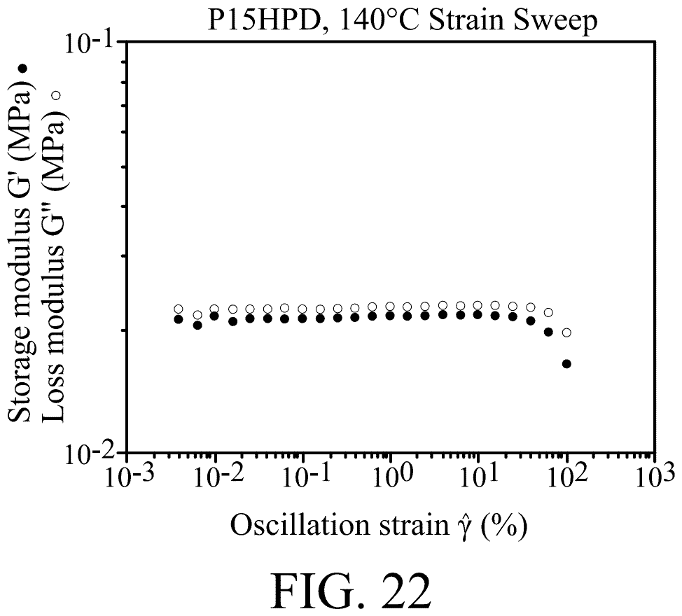

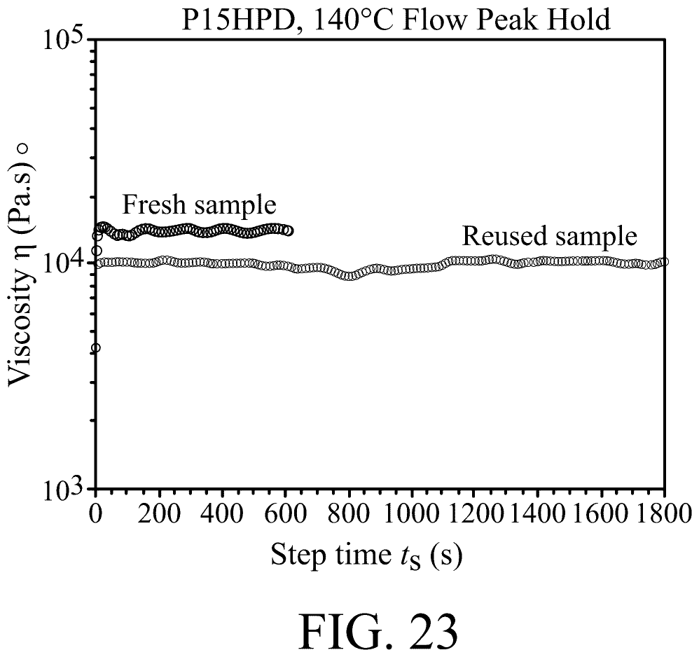

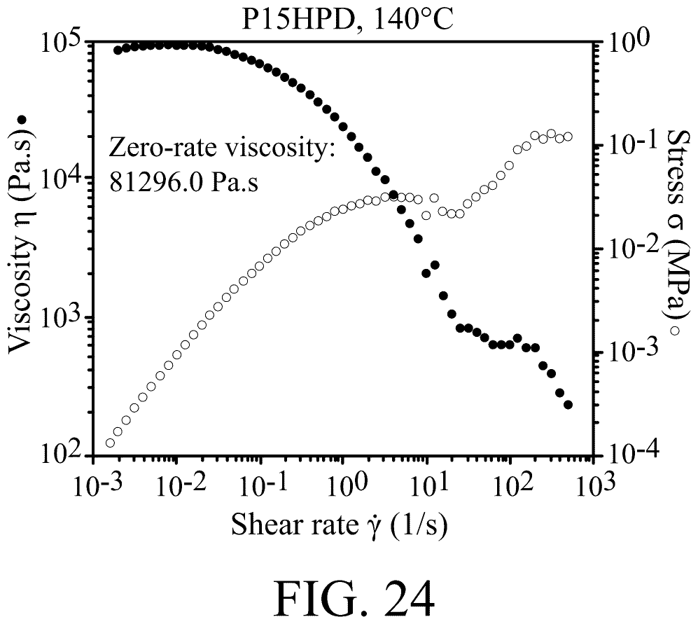

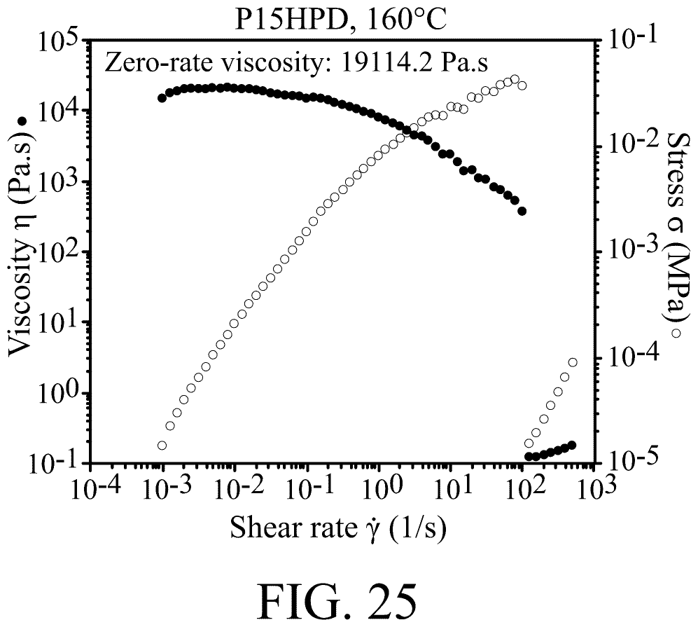

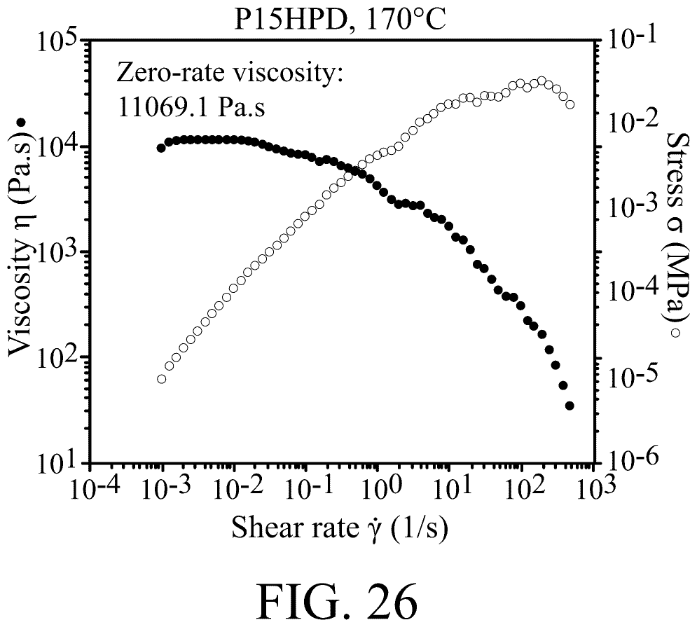

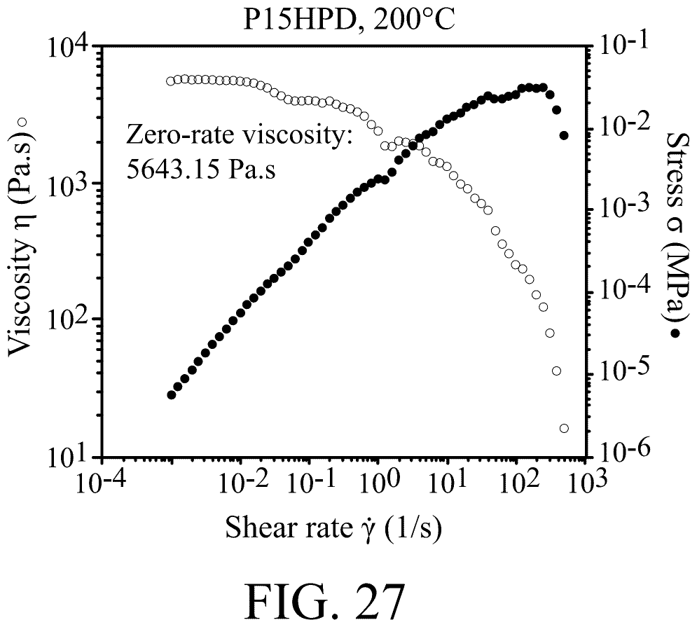

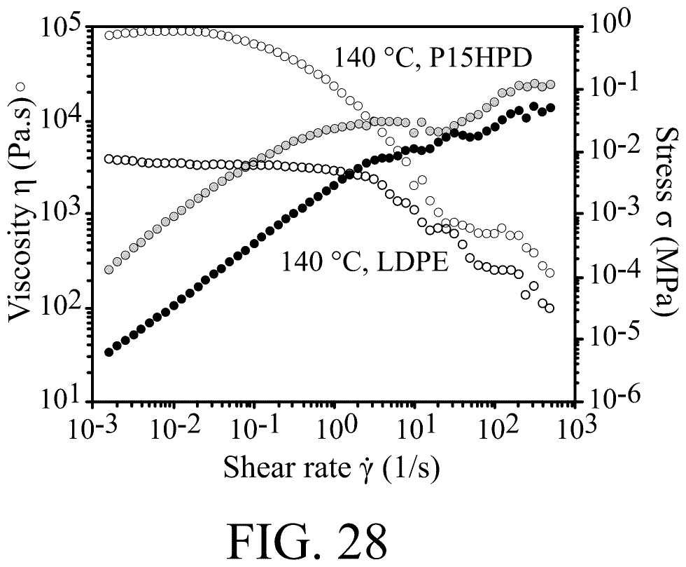

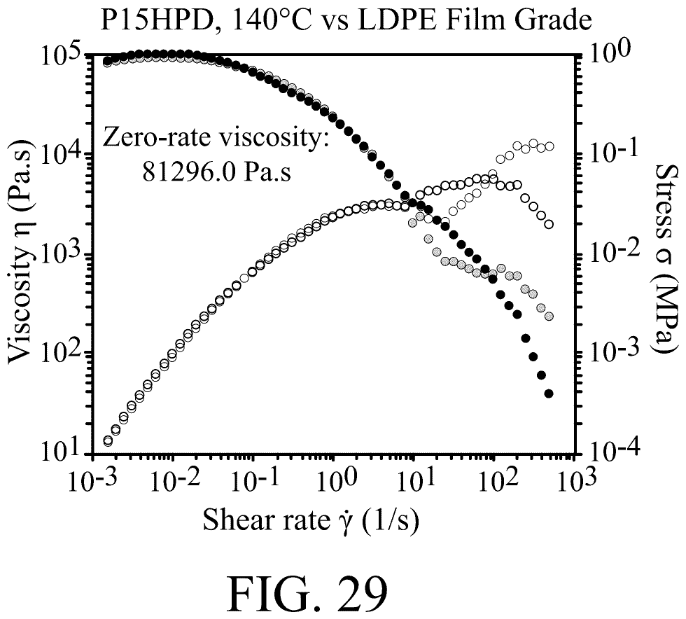

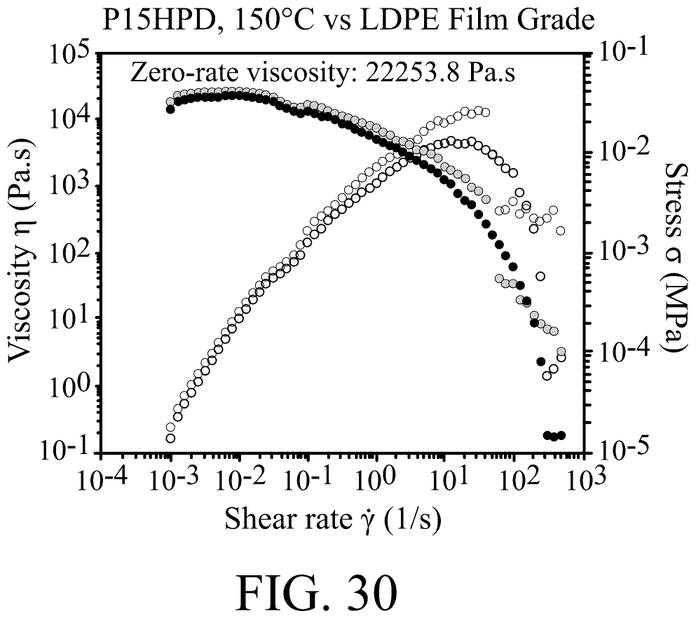

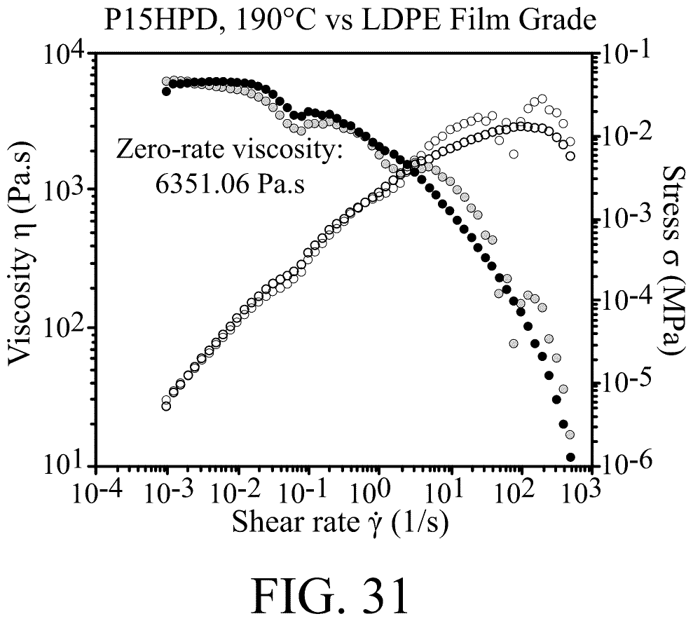

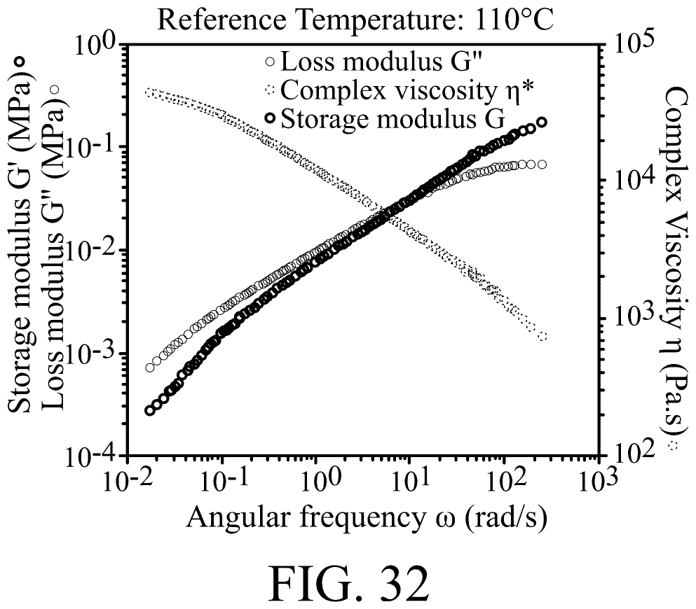

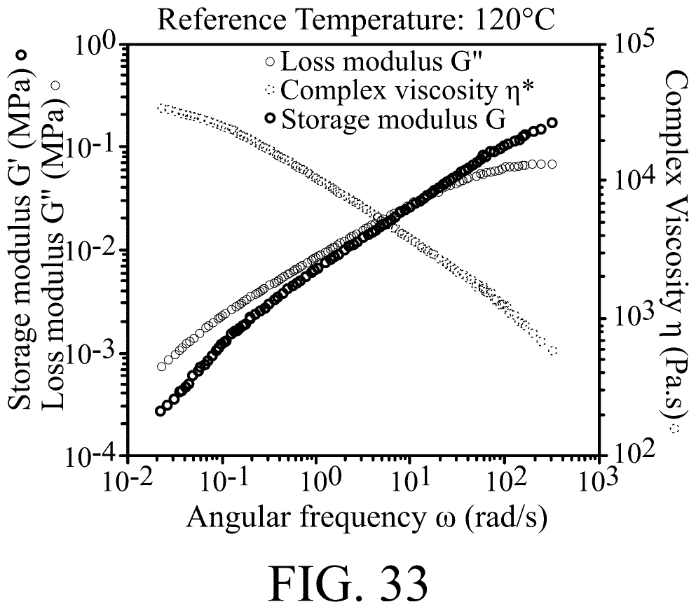

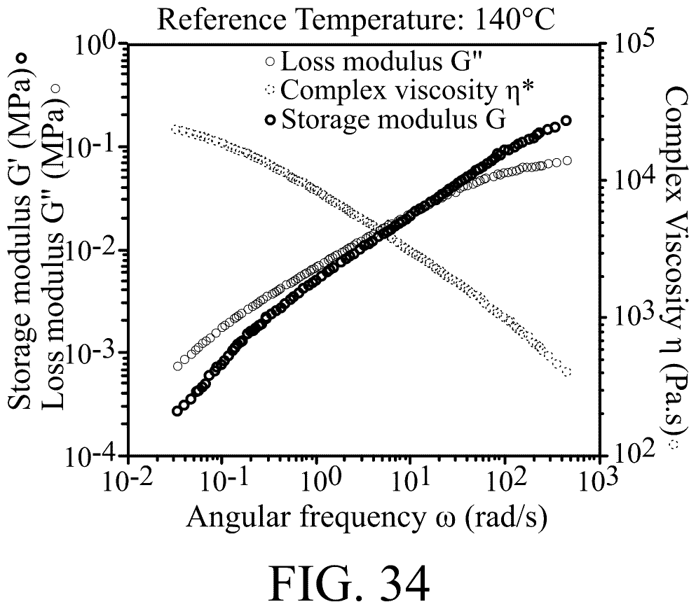

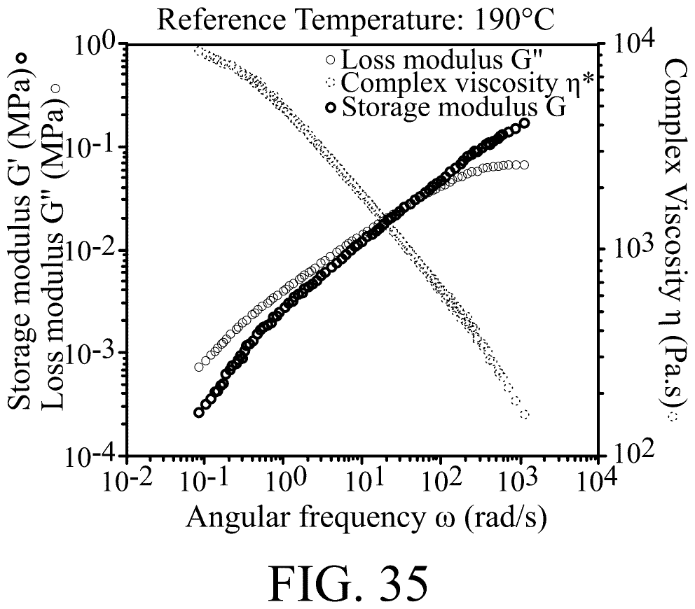

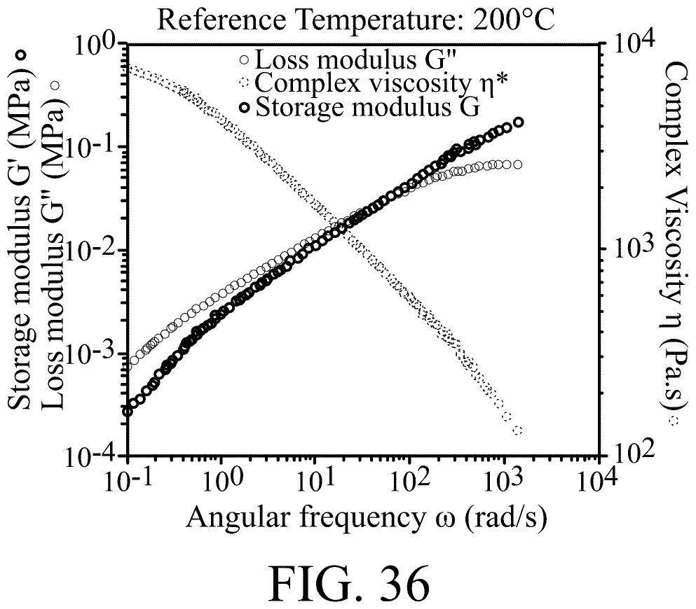

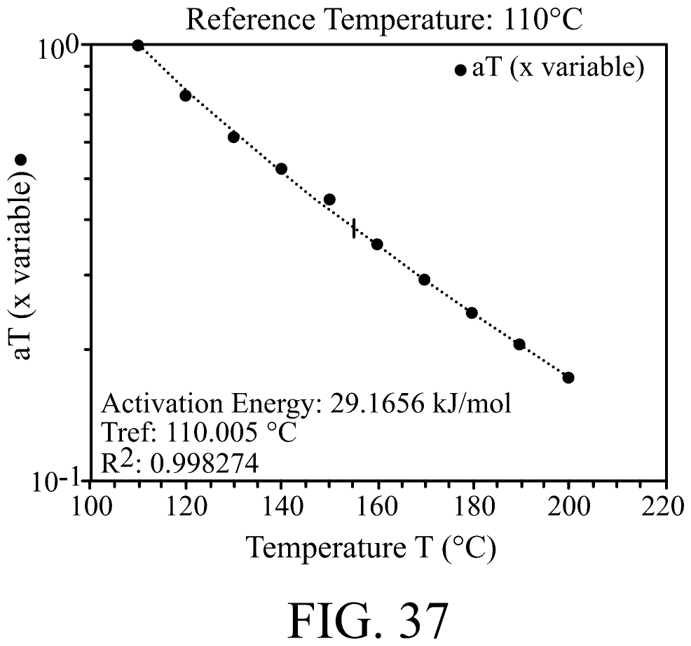

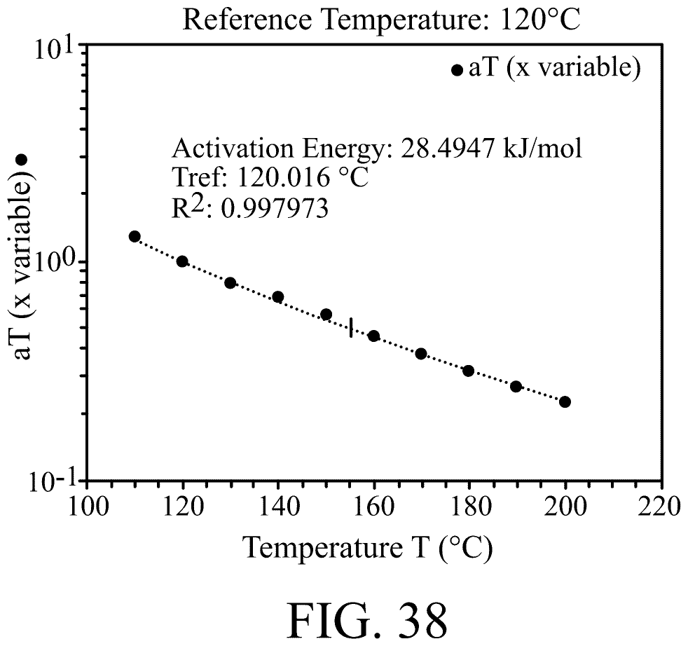

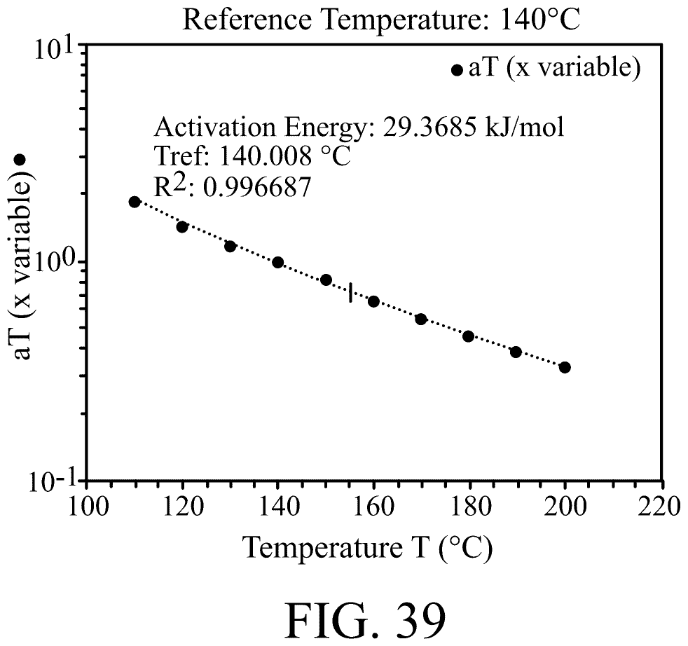

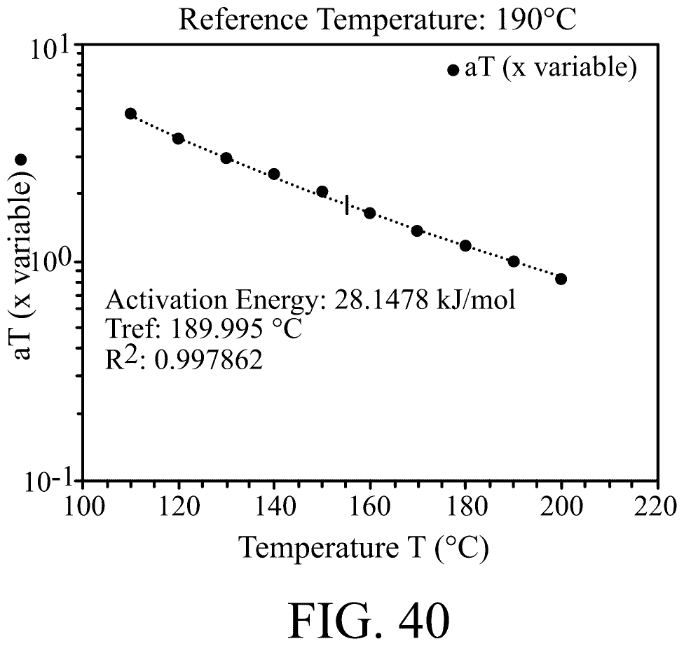

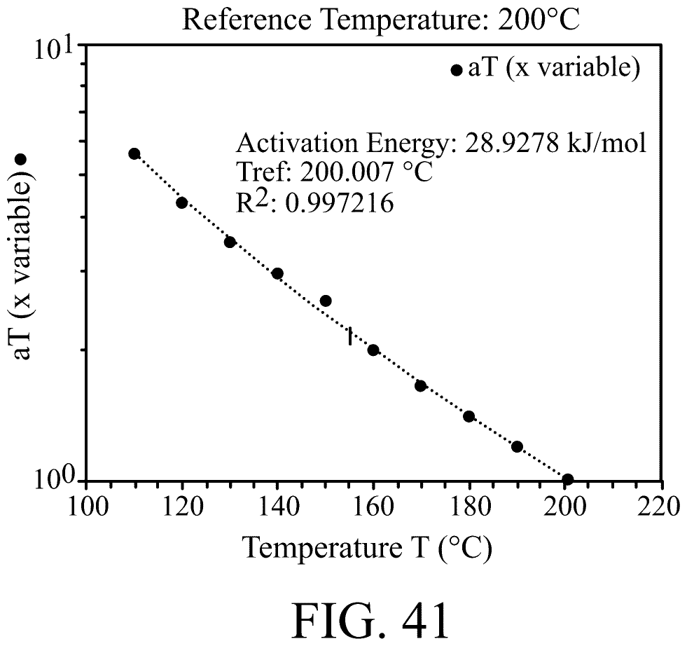

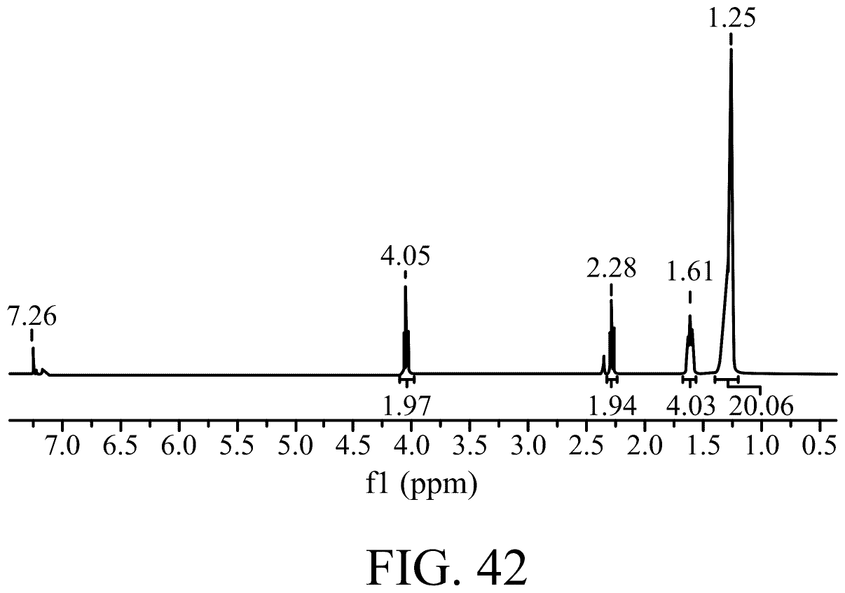

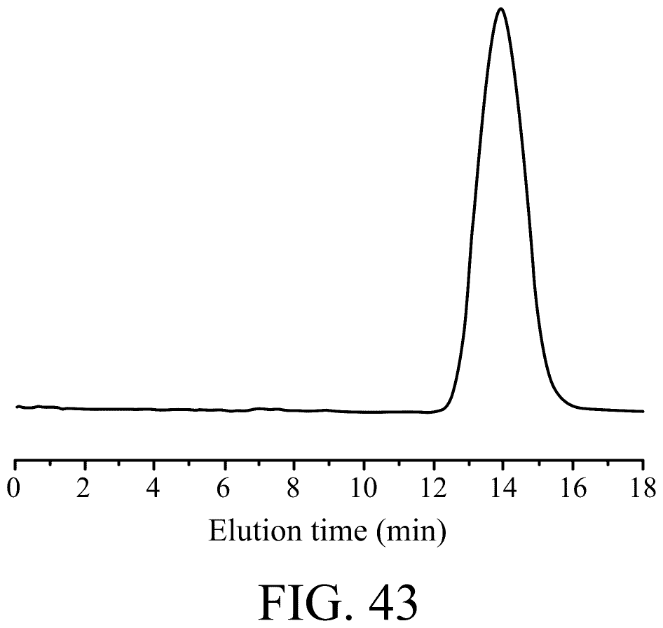

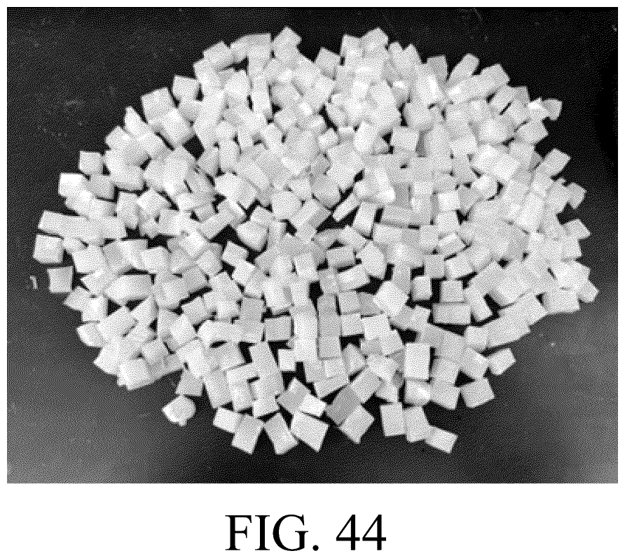

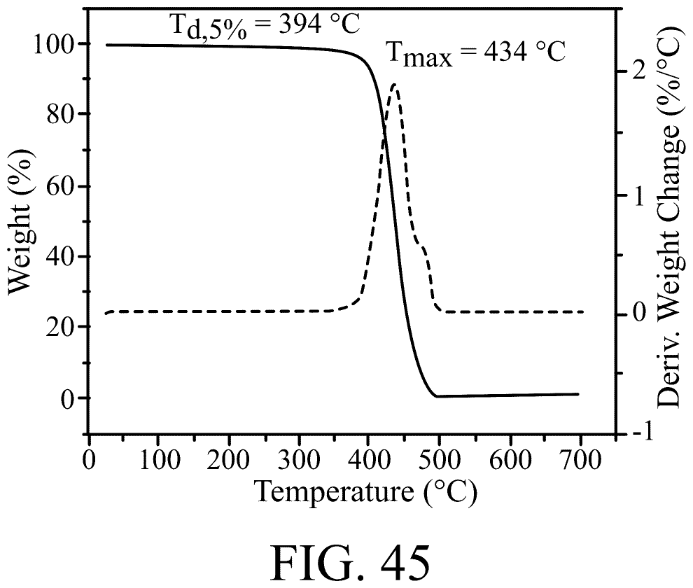

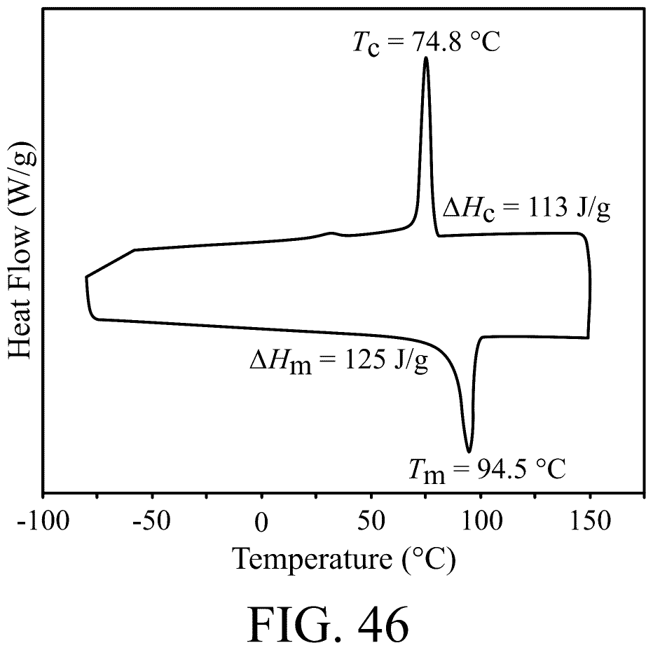

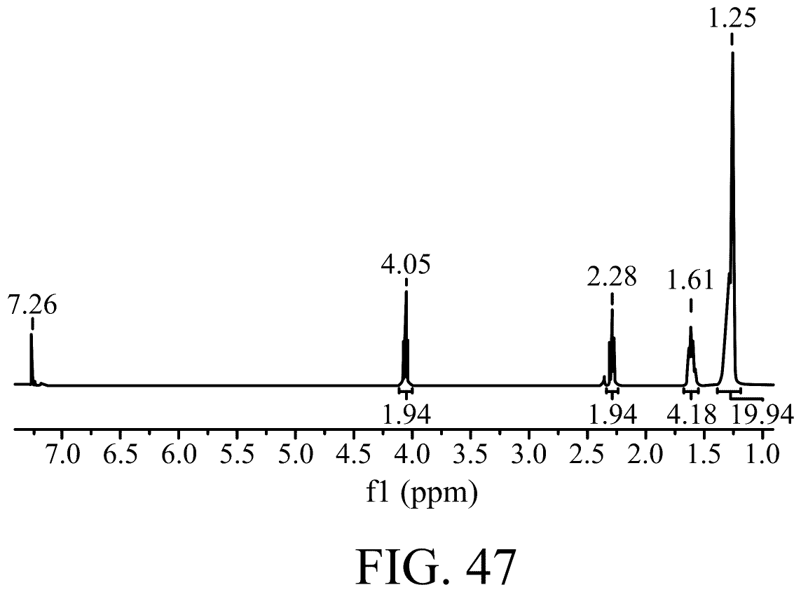

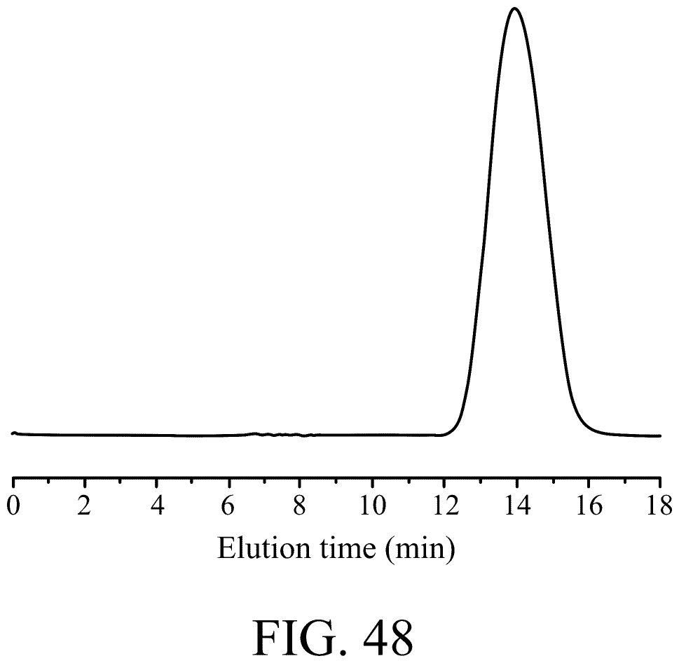

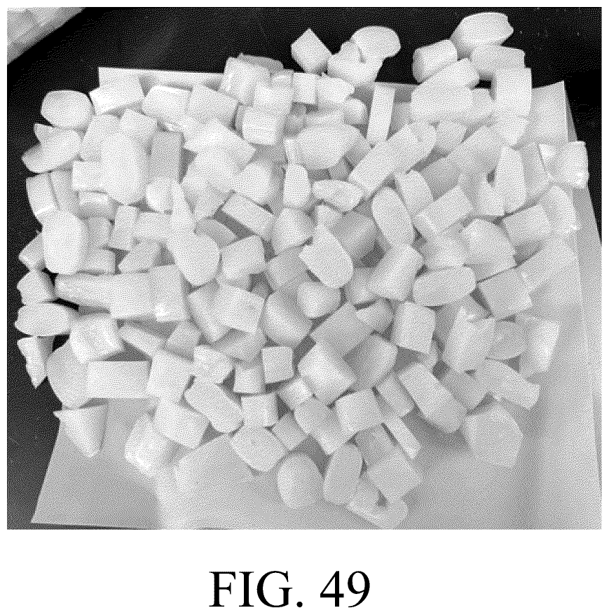

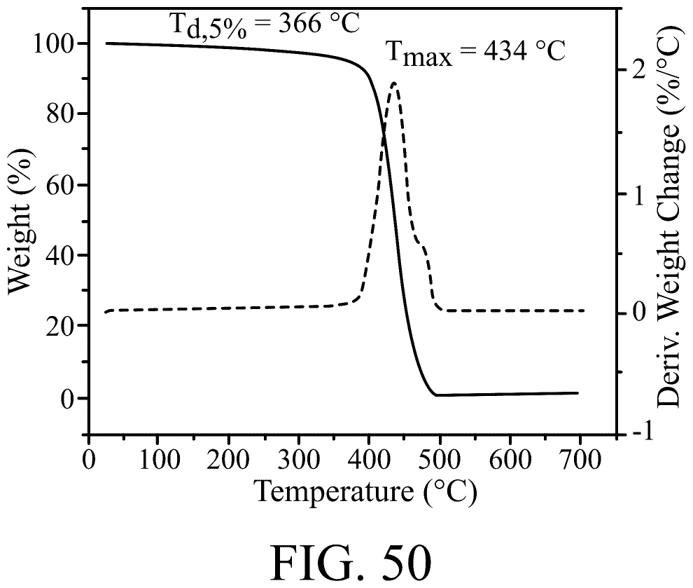

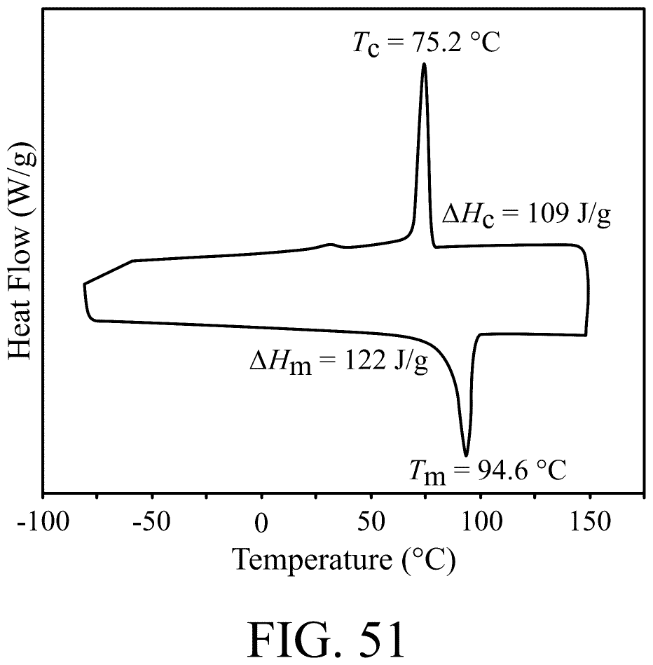

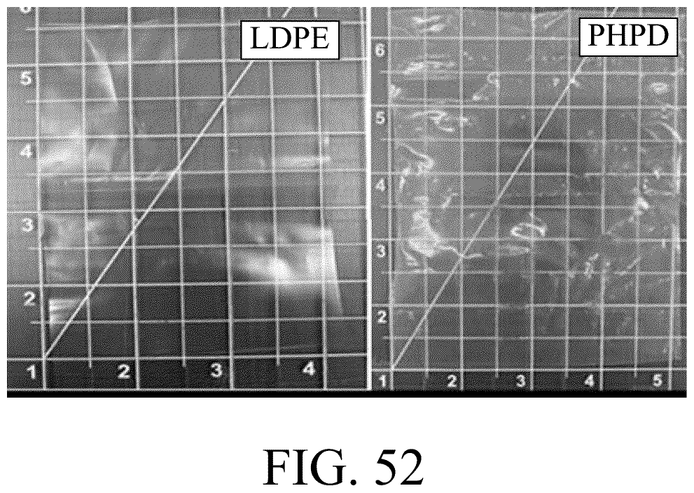

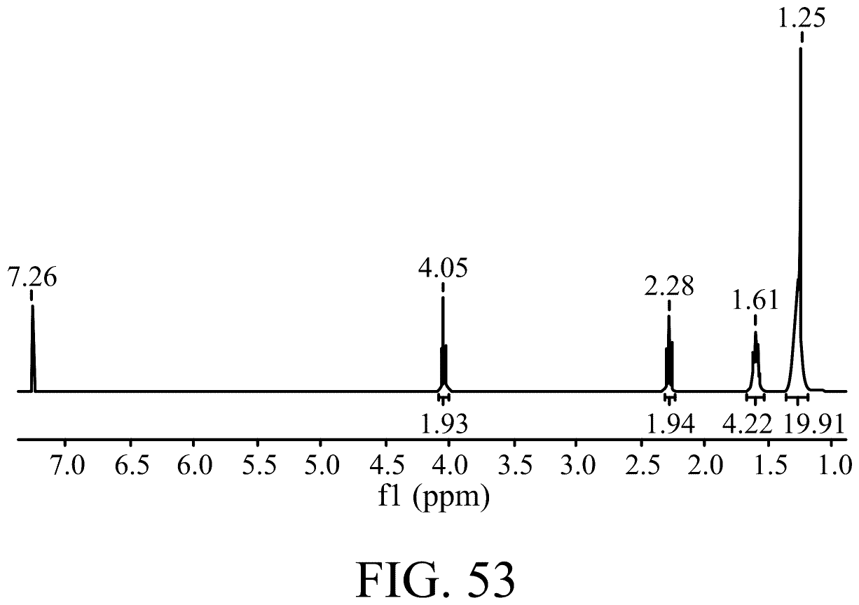

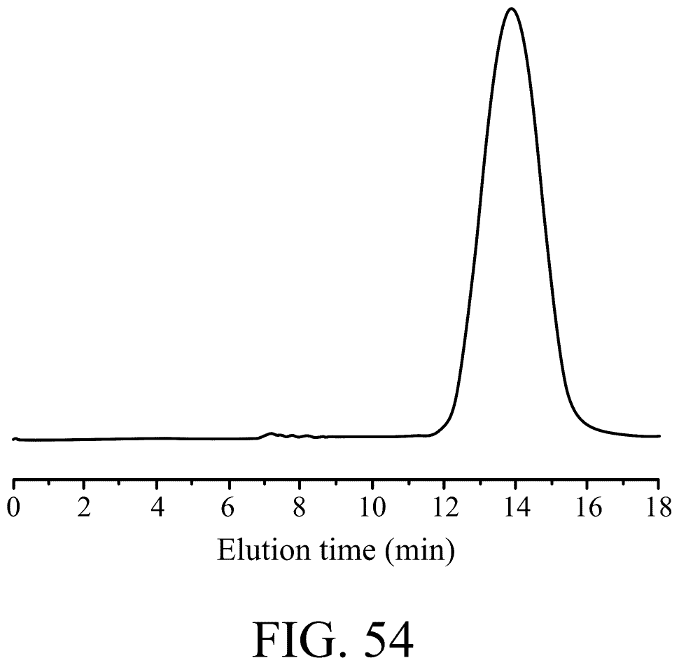

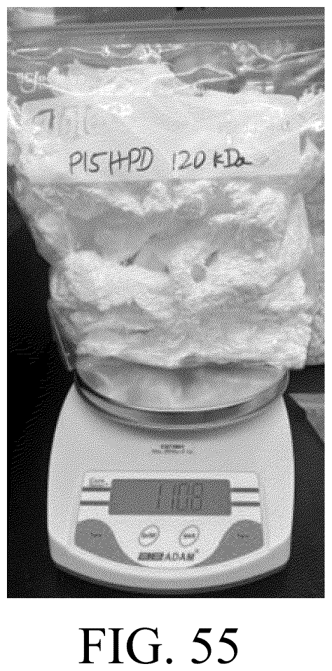

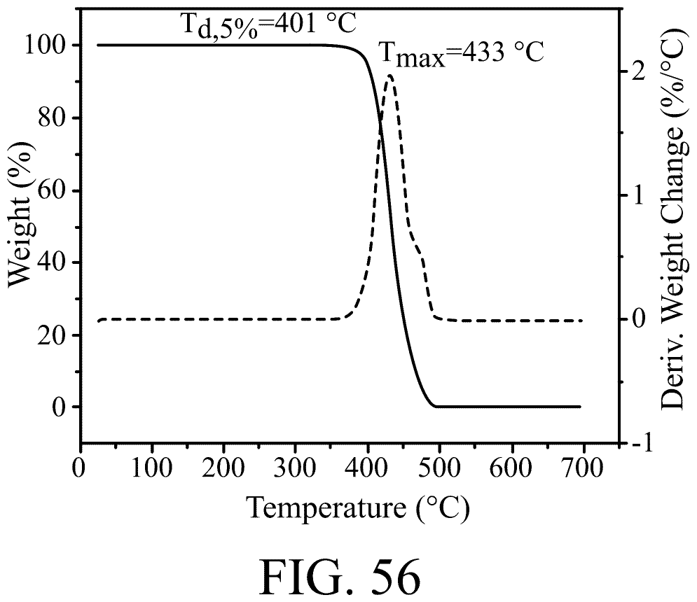

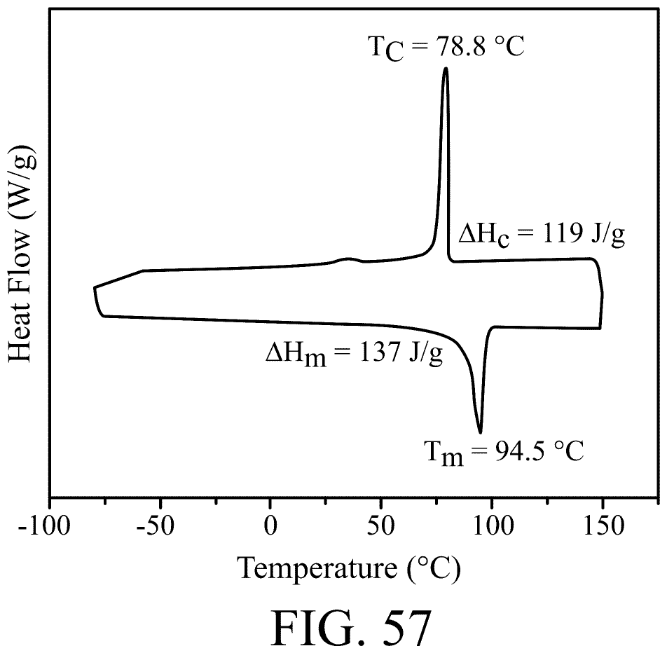

An exemplary method for synthesizing a polymacrolactone like that shown in Structure I is provided below. The focus of the following paragraphs is on the polymacrolactones, their physical properties, and performance metrics, as well as how these characteristics may be manipulated using additives to enable their use in blown film processing systems. The support for the numerical ranges for these physical properties and performance metrics are provided in FIGS. 2 and 4-77 and are summarized in the corresponding tables. FIG. 3 summarizes in which figures specific physical property and/or performance metrics are located.

In some embodiments of the present disclosure, a polymacrolactone synthesized according to the methods described herein may have a number average molecular weight (Mₙ) between 50 kDa and 500 kDa or between 70 kDa and 150 kDa with a polydispersity (Ð) between 1.01 and 2.5 or between 1.1 and 1.4 (dimensionless). A polymacrolactone may be characterized by a melting temperature (Tₘ) between 80.0° C. and 115.0° C., or between 90.0° C. and 100.0° C., or between 94.0° C. and 96.0° C. Other physical properties that may characterize a polymacrolactone according to some embodiments of the present disclosure include, an enthalpy of fusion (ΔHₘ) between 60 J/g and 200 J/g or between 120 J/g and 140 J/g, a crystallization temperature (T_{c}) between 60.0° C. and 150.0° C. or between 74.0° C. and 80.0° C., and/or an enthalpy of crystallization (ΔH_{c}) between 80 J/g and 200 J/g or between 109 J/g and 131 J/g.

Other physical properties that may characterize polymacrolactones synthesized according to the methods described herein may include a degradation temperature (T_{d}) between 360° C. and 500° C. or between 360° C. and 401° C., where the polymer exhibits less than or equal to about 5% weight loss when heated to T_{d} and/or a maximum degradation temperature (T_{d,max}) between 420° C. and 600° C. or between 420° C. and 450° C., where the polymer exhibits greater than about 50% weight loss when heated to T_{d},mₓ.

Performance metrics that may characterize a polymer according to some embodiments of the present disclosure, include a stress at break between 10 MPa and 80 MPa, between 20 MPa and 60 MPa, or between 30 MPa and 40 MPa; a strain at break between 200% and 1500%, or between 300% and 1200%, or between 600% and 900%; and/or a Young's modulus between 100 MPa and 1500 MPa or between 400 MPa and 750 MPa. In addition, a polymer like that shown in Structure I may have an end-group that includes at least one of a hydrogen atom, an alkyl group, an alkoxy group, an aromatic group, and/or a benzyloxy group, [symbol] where the end-group is attached to the covalent bonds, [symbol] , shown in Structure I.

Polymers like those shown in Structure I may have one or more of their physical properties and/or performance metrics modified by adding an additive that may include at least one of a heat stabilizer, an anti-oxidant, a processing aid, and/or an anti-blocking agent. After the new composition has been successfully formulated using the polymer and additive, the composition may be formed into a shape useful for downstream processes that may use the composition, e.g., blown film processing systems. Exemplary shapes include granules and/or pellets, which, among other things, may enable the use of composition in extruders and/or other mechanical systems.

The compositions may then be processed, e.g., by directing the granules and/or pellets to at least one of a blown process, a molded process, and/or a cast process resulting in the transformation of the composition from granules and/or pellets to a film. In some embodiments of the present disclosure, a film made of the polymers described herein may have an average thickness between 2.5 μm and 250 μm, or between 20 μm and 120 μm, or between 30 μm and 100 am. In some embodiments of the present disclosure, a film made of the polymers described herein may have a 2% secant modulus between 150 MPa and 750 MPa or between 300 MPa and 500 MPa and/or a heat seal strength between 10 N and 40 N or between 15 N and 30 N. In some embodiments of the present disclosure, a film made of the polymers described herein may have a clarity between 60% and 100% or between 70% and 100%, a transmittance between 60% and 100% or between 80% and 100%, and/or a haze less than 60% or less than 50%.

In some embodiments of the present disclosure, a film made of the polymers described herein may be manufactured by directing the polymer to a blown film extruder. In some embodiments of the present disclosure, a blown film extruder may be a single-screw extruder and/or twin-screw extruder. The operating conditions of a blown film extruder may be adjusted as needed for a particular polymer, e.g., polymacrolactone. So, the conditions provided herein are provided for exemplary purposes and may vary depending on the particular polymacrolactone being processed. For the example of forming a film from poly-15-hydroxypentadecanoate, a single screw extruder may be operated with a barrel temperature between 150° C. and 250° C. or between 200° C. and 240° C., a die temperature between 145° C. and 245° C. or between 195° C. and 235° C., and/or an extruder speed between 60 RPM and 300 RPM or between 160 RPM and 180 RPM. In some embodiments of the present disclosure, a single-screw extruder for forming a film from poly-15-hydroxypentadecanoate may be operated at a Blow-Up Ratio (BUR) between 2.0 and 3.0, or between 1.5 and 5.0, or between 2.3 and 3.5 and/or a Drawdown Ratio (DDR) between 3.0 and 6.0, or between 2.0 and 8.0, or between 4.5 and 6.5.

Referring again to Structures I and II, polymers, e.g., polymacrolactones, like those described above and shown in Structure I may be produced by polymerizing one or more macrolactones as shown in Structure II. The methods described herein for synthesizing polymacrolactones are unique and result in polymacrolactones that have improved characteristics compared to other polymers such as, for example, other polymacrolactones, polyethylene, and polypropylene. In brief, the synthesis methods described herein are performed neat (i.e., in bulk), while still achieving conversions of macrolactones to polymacrolactones between 80% and 100% conversion or as high as between 98.0% and 99.9%. Further, the resultant polymacrolactones may be distinguished over incumbent polymacrolactones by a much narrower polydispersity (Ð) between 1.01 and 2.5 or between 1.1 and 1.4 (dimensionless). Together, these advantages result in a simpler and less expensive synthesis method and final polymacrolactones that can be more reliably and predictably used in downstream processes, e.g., blown film extruders, to make better quality and better preforming polymacrolactone films.

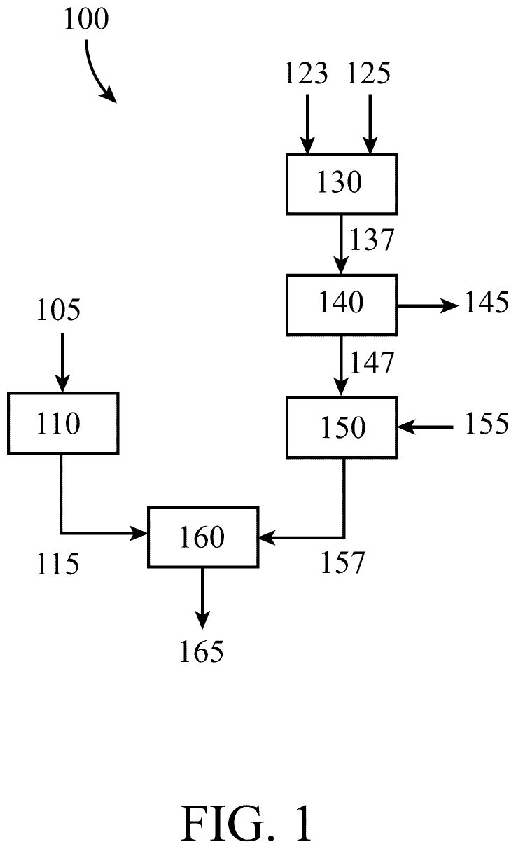

FIG. 1 illustrates a method 100 for making polymers like those described herein, according to some embodiments of the present disclosure. This exemplary method 100 prepares a macrolactone 105 (e.g., 15-hydroxypentadecanoate and/or 16-hydroxyhexadeconoate) in parallel with preparing the catalyst 147 before they are combined, resulting in the polymerizing 160 of the macrolactone 105 to produce the target polymacrolactone 165.

Referring to FIG. 1, a macrolactone 105 in a solid phase may be subjected to a melting 110 to transform it from a solid phase to a liquid phase, creating a liquid macrolactone 115. Referring again to Structure I, in some embodiments of the present disclosure, a solid macrolactone with m equal to 11 or 12, may melt at a temperature between 34° C. and 38° C., whereas macroloactones having m between 13 and 15, inclusively, may melt between 23° C. and 25° C. In some embodiments of the present disclosure, melting 110 may be performed in a stirred tank reactor and/or a twin-screw extruder. Once formed, a liquid macrolactone 115 may then be combined with a solution 157 containing a catalyst 146, resulting in the polymerization of the macrolactone 115 to produce the targeted polymacrolactone 165. Before providing more details on the polymerizing 160, the steps for preparing the solution 157 containing the catalyst 147 will be explained.

Referring again to FIG. 1, a first solution 137 may be prepared by combining a precatalyst 123 and an initiator 125, both in a liquid form. In some embodiments of the present disclosure, an alcohol may be utilized as an initiator 125, for example benzyl alcohol (BnOH) and/or iso-propyl alcohol. In some embodiments of the present disclosure, a precatalyst 123 may include at least one of La[N(SiMe₃)₂]₃ and/or tin(II) octoate (SnOct₂) and/or phosphazene base P₄-t-Bu [(1-tert-Butyl-4,4,4-tris(dimethylamino)-2,2-bis[tris(dimethylamino)-phosphoranylidenamino]-2λ⁵,4λ⁵-catenadi(phosphazene)]. In some embodiments of the present disclosure, a precatalyst 123 and an initiator 125 may be provided in the combining 130 step at a mass ratio (precatalyst:initiator) between 1:5 and 5:1 or between 1.5:1 and 2.5:1.

In some embodiments of the present disclosure, combining 130 may be performed in a stirred tank reactor and/or twin screw extruder at a temperature between 23° C. and 30° C. or between 23° C. and 25° C., at a pressure between 0.1 bar and 3 bar or between 0.5 bar and 2 bar, and with a stirring speed between 100 RPM and 600 RPM or between 150 RPM and 200 RPM. Once the combining 130 is complete, resulting in the first solution 137, the first solution 137 may be subjected to treating 140, which among other things, may convert the precatalyst 123 and the initiator 125 to the catalyst 147, and the removing of unwanted volatile components 145 produced during the reaction of the precatalyst 123 with the initiator 125. In some embodiments of the present disclosure, a volatile component 145 may include an amine, for example at least one of bis(trimethylsilyl)amine and/or hexamethyldisilazane (HMDS). In some embodiments of the present disclosure, a volatile component 145 may be removed from the solution of reacting precatalyst 123 and initiator 125 by providing vacuum to the unit operation in which the treating 140 is performed, e.g., a stirred tank reactor and/or twin-screw extruder. In some embodiments of the present disclosure, the pressure during treating 140 may be between 0.1 bar and 3 bar or between 0.5 bar and 2 bar.

Referring again to FIG. 1 and returning to the polymerizing 160 of the liquid macrolactone 115, a catalyst 147, when in a solid form, may be diluted with a solvent 155 in an adding 150 step, wherein the adding 150 results in the forming of a second solution 157. The second solution 157 may then be combined with the liquid macrolactone 115, resulting in the polymerizing 160 of the liquid macrolactone 115 to form the polymacrolacotone 165. In some embodiments of the present disclosure, only a small amount of solvent 155 may be added to the catalyst 147, with reasons for adding the solvent 155 including: 1) the minimization or elimination of catalyst losses occuring during the transfer of the second solution 157 to the polymerizing 160 step, and 2) enabling rapid mixing of the second solution 157 with the liquid macrolactone 115. The first reason, to minimize losses, can be significant at laboratory scale, however, may not be a concern at manufacturing scale.

The addition of the second solution 157 to the liquid macrolactone 115 results in the polymerization, i.e., polymerizing 160, of the liquid macrolactone 115. In some embodiments of the present disclosure, polymerizing 160 may be performed in a stirred tank reactor and/or twin-screw extruder. In some embodiments of the present disclosure, polymerizing 160 may be performed at a temperature between 40° C. and 200° C. or between 70° C. and 110° C. for a period of time between 1 minute and 12 hours or between 30 minutes and 6 hours. Further, polymerizing 160 may be performed at a pressure between 0.5 bar and 10 bar or between 1 bar and 4 bar, and, when performed in a stirred tank reactor, with stirring speed between 100 RPM and 600 RPM or between 150 RPM to 200 RPM.

In some embodiments of the present disclosure, for example at full-scale (i.e., manufacturing scale), melted macrolactones 115 and catalyst 147 (with or without a solvent 155) may be fed to a continuous stirred tank reactor equipped with an extruder at the outlet where the polymacrolactone 165 may exit the reactor via the extruder, in the liquid phase, to feed a pelletizer. In some embodiments of the present disclosure, macrolactone 115 and catalyst 147 (with our without a solvent 155) may be fed directly to a twin-screw extruder to produce the polymacrolactone 165 via reactive extrusion. In some embodiments of the present disclosure, a second solution 157 may be manufactured by combining a catalyst 1147 and a solvent 155 in a static mixer. In some embodiments of the present disclosure, a large catalyst batch may be produced in a separate unit operation before being fed to a continuous stirred tank polymerization reactor.

### Experimental Results

Reaction 1 illustrates the polymerization of 15-hydroxypentadecanoate (ω-PDL) to produce poly-15-hydroxypentadecanoate (PHPD).

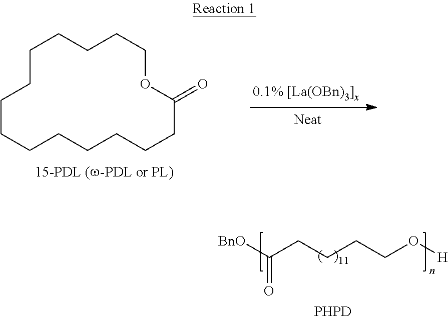

Five different polymerization experiments (labeled Experiments #1, #2, #3, #4, and #5) were completed first, using 15-hydroxypentadecanoate (ω-PDL) to produce poly-15-hydroxypentadecanoate (PHPD). The generalized procedure that was used for each polymerizing 160 was as follows. Each polymerizing 160 step was performed neat (i.e., in bulk) in a reactor flask having the volume required for the target scale; between 134 g and 172 g target weight of final polymacrolactone 165. Precatalyst 123, La[N(SiMe₃)₂]₃, and initiator 125 BnOH were combined and stirred for about 15 minutes at 25° C. in an inert glovebox and dried for about 15 minutes under vacuum, then dissolved in a solvent 155, toluene. Subsequently, the catalyst solution 157 was transferred to melted ω-PDL 115, which was at a temperature between 34° C. and 38° C. The sealed reactor flask was removed from the glovebox and stirred at 100° C. for 1 hour. The polymerizing mixture became viscous after a desired period, and an aliquot was taken from the reaction mixture and prepared for ¹H NMR analysis to obtain the percent macrolactone conversion data. The reactor flask was opened, and the polymerization was quenched by the addition of benzoic acid in chloroform and subsequently dissolved with CHCl₃ for about 3 days at 45-50° C. using an overhead stirrer, followed by precipitation of the polymacrolactone in methanol. The mixture was filtered, and a fibrous polymacrolactone precipitate was washed with methanol. The resulting fibrous white polymacrolactone solid was dried in a vacuum at −25° C. for 5 days to a constant weight resulting in pure PHPD. Yield, Mₙ, M_{w}, and Ð were determined for each sample of PHPD obtained. Reaction conditions for each polymerization are summarized in Table 1. Polymer properties are summarized in Tables 2A - 21. Table 3 summarizes which figures illustrate physical properties and/or performance metrics for each polymer sample synthesized (for Experiments #1 through #5): NMR data, GPC traces, photos of isolated polymer, TGA traces, DSC traces, DMA traces, tensile test results, and shear viscosity. Table 4 illustrates stress, strain, and Young's modulus results for the polymer from Experiment #1.

Further, two experiments were completed where 16-hydroxyhexadecanoate (16-HDL) was polymerized to produce poly-16-hydroxyhexadecanoate (PHHD), as shown below in Reaction 2. The second of the two experiments further included a post-polymerization purification step. The physical properties and performance metrics of the polymacrolactones produced from these two experiments are summarized in the tables below and are labeled as Experiments #6A without purification and #6B with purification. Experiment #6A was performed in essentially the same fashion as described above for Experiments #1-5.

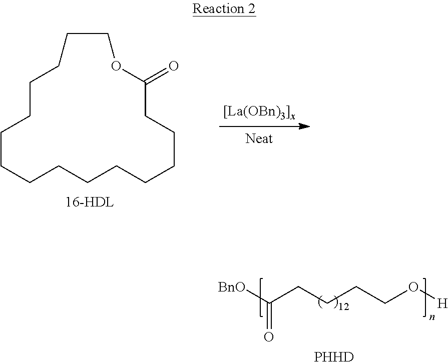

Experiment #6B with purification was performed identically as Experiment #6A without purification. The entire procedure for Experiment #6B with purification was performed as follows. The 14.7 g-scale neat ring-opening polymerization was performed in a 200 mL reactor flask. A precatalyst La[N(SiMe₃)₂]₃ (0.059 mmol, 0.037 g) and initiator BnOH (0.177 mmol, 0.019 g) mixture were stirred for 10 minutes at 25° C. in an inert glovebox and dried for 10 minutes under vacuum, then dissolved in 1 mL toluene. Subsequently, the catalyst solution was transferred to 15.0 g of 16-HDL (0.059 mol) melt (34-38° C.). The sealed reactor flask was removed from the glovebox and stirred at 100° C. for 4.25 hour. The mixture became viscous after a desired period, and an aliquot was taken from the reaction mixture and prepared for ¹H NMR analysis to obtain the percent monomer conversion data (>98%). The reactor flask was opened, and the polymerization was quenched by the addition of 3 mL benzoic acid in chloroform (10 mg/mL) and dissolved with 200 mL CHCl₃ at 45-50° C. using an overhead stirrer, followed by precipitation of the polymacrolactone in 1.5 L methanol. The mixture was filtered, and the fibrous precipitated polymacrolactone was washed with 5x 50 mL methanol. The resulting fibrous white polymer solid was dried in a vacuum at −25° C. for 5 days to constant weight of 14.7 g of pure PHHD with an isolated yield of 98%. Characterization resulting in: Mₙ=142 kDa, M_{w}=193 kDa, Ð=1.36.

In addition, an experiment was conducted polymerizing a mixture of ω-PDL (15-hydroxypentadecanoate) and 16-HDL (16-hydroxyhexadecanoate) on an equal mass basis, to synthesize a copolymer (PHPD-co-PHHD). This reaction is summarized below in Reaction 3. The physical properties and performance metrics of this copolymer are summarized in the tables below and are labeled as Experiment #6C. The starting monomers (ω-PDL and 16-HDL were added in series, as described in more detail below. The term “Scale” refers to the amount of product, i.e., polymacrolactone, obtained from each experiment, where monomer conversion is equal to monomer/product x 100%. The single 13C peak at carbonyl region indicates a copolymer instead of mixture of homopolymers (see FIGS. 72 and 73).

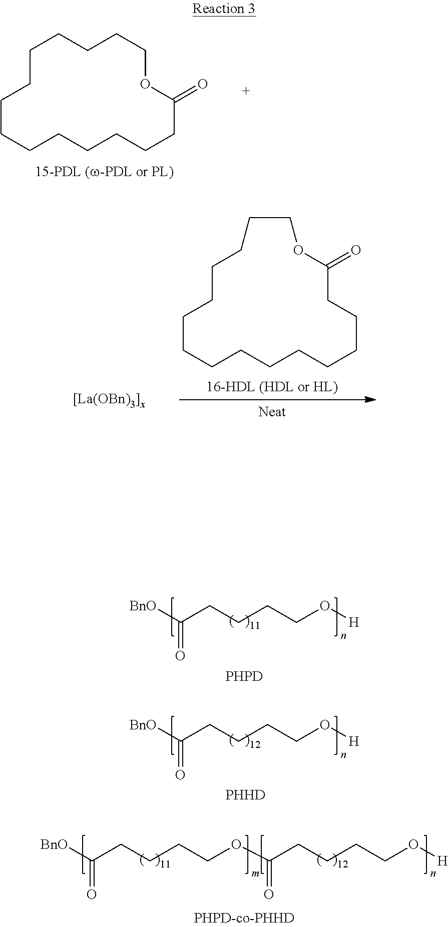

Experiment #6C was performed as follows. The 25.0 g-scale neat ring-opening polymerization was performed in a 200 mL reactor flask. A precatalyst La[N(SiMe₃)₂]₃ (0.121 mmol, 0.076 g) and initiator BnOH (0.364 mmol, 0.039 g) mixture were stirred for 10 minutes at 25° C. in an inert glovebox and dried for 10 minutes under vacuum, then dissolved in 1 mL toluene. Subsequently, the resultant catalyst solution was transferred to 15.0 g of melted ω-PDL (0.062 mol) (34-38° C.). After 10 minutes of stirring, 15.0 g of 16-HDL (0.059 mol) was added. The sealed reactor flask was removed from the glovebox and stirred at 100° C. for 18 h. The mixture became viscous after a desired period, and an aliquot was taken from the reaction mixture and prepared for ¹H NMR analysis to obtain the percent monomer conversion data. The reactor flask was opened, and the polymerization was quenched by the addition of 5 mL benzoic acid in chloroform (10 mg/mL) and dissolved with 500 mL CHC₃ at 45-50° C. using an overhead stirrer, followed by precipitation of the copolymer in 3.0 L methanol. The mixture was filtered, and the fibrous precipitated copolymer was washed with 5×100 mL methanol. The resulting solid fibrous white copolymer was dried in a vacuum at ˜25 C for 5 days to a constant weight, resulting in 25.0 g of the pure copolymer with an isolated yield of 83% and characterized as follows: Mₙ=61 kDa, M_{w}95.3 kDa, Ð=1.56.

TABLE 1
Reaction Conditions

| | scale | monomer | precatalyst | initiator | precatalyst/ | monomer/ | rxn T | rxn time |
|---|---|---|---|---|---|---|---|---|
| Exp# | [g] | [g] | [g] | [g] | initiator | initiator | [° C.] | [hr] |
| 1 | 134 | 150 | 0.39 | 0.20 | 1.95 | 750 | 100 | 1 |
| 2 | 150 | 150 | 0.39 | 0.20 | 1.95 | 750 | 100 | 12 |
| 3 | 172 | 172 | 0.44 | 0.23 | 1.91 | 748 | 100 | 12 |
| 4 | 550 | 550 | 1.42 | 0.74 | 1.92 | 743 | 100 | 12 |
| 5 | 111 | 150 | 0.19 | 0.10 | 1.90 | 1500 | 100-115 | 72 |
| 6A | 15 | 15 | 0.037 | 0.019 | 1.95 | 789 | 100 | 6 |
| 6B | 14.7 | 15 | 0.037 | 0.019 | 1.95 | 789 | 100 | 4.25 |
| (purified) | | | | | | | | |
| 6C | 25 | 15 + 15* | 0.076 | 0.039 | 1.95 | 769 | 100 | 18 |

*Indicates 15 g of ω-PDL and 15 g 16-HDL

TABLE 2A
Polymer properties

| | monomer | | | | | | | |
|---|---|---|---|---|---|---|---|---|
| | conversion | Mn | Mw | D | Tm | ΔHm | Tc | ΔHc |
| Exp# | [%] | [kDa] | [kDa] | [—] | [° C.] | [J/g] | [° C.] | [J/g] |
| 1 | 89 | 92.6 | 124 | 1.33 | 95.3 | 140 | 78.8 | 128 |
| 2 | 100 | 104 | 133 | 1.28 | 94.5 | 140 | 75.6 | 131 |
| 3 | 100 | 102 | 134 | 1.31 | 94.5 | 125 | 74.8 | 113 |
| 4 | 100 | 104 | 138 | 1.33 | 94.6 | 122 | 75.2 | 109 |
| 5 | 80 | 120 | 171 | 1.42 | 94.5 | 137 | 78.8 | 119 |
| 6A | 100 | 149 | 164 | 1.09 | 94.0 | 139 | 75.0 | 127 |
| 6B | 98 | 142 | 193 | 1.36 | 93.0 | 139 | 78.3 | 130 |
| (purified) | | | | | | | | |
| 6C | 83 | 61 | 95.3 | 1.56 | 91.4 | 154 | 76.1 | 139 |

TABLE 2B
Polymer properties

| | | degradation | degradation | Isothermal TGA at | Isothermal TGA at |
|---|---|---|---|---|---|
| | Tg | T 5% | T max | 100° C. for 120 min | 200° C. for 120 min |
| Exp# | [° C.] | [° C.] | [° C.] | under air | under air |
| 1 | −24.7 | 397 | 429 | Not available (NA) | 2.7% weight loss |
| 2 | −22.9 | 389 | 429 | 1.5% weight loss | 2.8% weight loss |
| 3 | NA | 394 | 434 | NA | NA |
| 4 | NA | 366 | 434 | NA | NA |
| 5 | NA | 401 | 433 | NA | NA |
| 6A | −26.1 | 323 | 429 | 1.4% (at 150° C.) | NA |
| 6B (purified) | −26.1 | 394 | 427 | NA | NA |
| 6C | NA | 390 | 426 | NA | NA |

TABLE 2C
Polymer properties

| | | Zero shear | Zero shear | Zero shear | Zero shear | Zero shear | Zero shear |
|---|---|---|---|---|---|---|---|
| | processing | viscosity | viscosity | viscosity | viscosity | viscosity | viscosity |
| | T [° C.] | at 140° C., | at 150° C., | at 160° C., | at 170° C., | at 190° C., | at 200° C., |
| Exp# | window | [Pa · s] | [Pa · s] | [Pa · s] | [Pa · s] | [Pa · s] | [Pa · s] |
| 1 | NA | NA | NA | NA | NA | NA | NA |
| 2 | 110-190 | 81296 | 22254 | 19114 | 11069 | 6351 | 5643 |
| 3 | NA | NA | NA | NA | NA | NA | NA |
| 4 | NA | NA | NA | NA | NA | NA | NA |
| 5 | NA | NA | NA | NA | NA | NA | NA |
| 6A | 150° C. | NA | 7231 | NA | NA | NA | NA |
| 6B | NA | NA | NA | NA | NA | NA | NA |
| (purified) | | | | | | | |
| 6C | NA | NA | NA | NA | NA | NA | NA |

TABLE 2D
Polymer properties

| | melt processability | Arrhenius activation |
|---|---|---|
| | (shear viscosity | energy (melt flow) |
| | versus time data) at | from time-temperature |
| Exp# | process temperatures | superposition [kJ/mol] |
| 1 | No degradation or loss of MW | NA |
| | observed at 120° C. and 200° C. | |
| 2 | No degradation or loss of MW | 29 |
| | observed at 140° C. | |
| 3 | NA | NA |
| 4 | NA | NA |
| 5 | NA | NA |
| 6A | No degradation or loss of MW | NA |
| | observed at 160° C. | |
| 6B (purified) | NA | NA |
| 6C | NA | NA |

TABLE 2E
Polymer properties (see FIGS. 58A-58J)

| | melt strength | melt strength | melt strength | melt strength |
|---|---|---|---|---|
| | and stretch | and stretch | and stretch | and stretch |
| Exp# | ratio at 145° C. | ratio at 155° C. | ratio at 165° C. | ratio at 175° C. |
| 1 | NA | NA | NA | NA |
| 2 | 11 cN and 20 | 9.6 cN and 25 | 6.8 cN and 20 | 5.2 cN and 25 |
| | (stretch ratio) | (stretch ratio) | (stretch ratio) | (stretch ratio) |
| 3 | NA | NA | NA | NA |
| 4 | NA | NA | NA | NA |
| 5 | NA | NA | NA | NA |

TABLE 2F
Polymer properties

| | | Onset of melt fracture | melt flow rate/ | melt flow rate/ |
|---|---|---|---|---|
| | melt strength and | at 100° C. (capillary | index, at 140° C., | index, at 140° C., |
| Exp# | stretch ratio at 190° C. | rheometer) | 2.16 kg, 5 min | 21.6 kg, 30 s |
| 1 | NA | NA | NA | NA |
| 2 | 2.3 cN and 25 | No melt fracture | 1.56 g/10 min | 52.8 g/10 min |
| | (stretch ratio) | at 145-190 [C.] | | |
| 3 | NA | NA | NA | NA |
| 4 | NA | NA | NA | NA |
| 5 | NA | NA | NA | NA |

TABLE 2G
Polymer properties

| | melt flow | melt flow | melt flow | melt flow |
|---|---|---|---|---|
| | rate/index, | rate/index, | rate/index, | rate/index, |
| | 150° C., 2.16 | 150° C., 21.6 | 160° C., 2.16 | 160° C., 21.6 |
| Exp# | kg, 5 min | kg, 30 s | kg, 90 s | kg, 15 s |
| 1 | NA | NA | NA | NA |
| 2 | 1.92 g/10 min | 78.0 g/10 min | 8.80 g/10 min | 293 g/10 min |
| 3 | NA | NA | NA | NA |
| 4 | NA | NA | NA | NA |
| 5 | NA | NA | NA | NA |

TABLE 2H
Polymer properties

| | melt flow | melt flow | melt flow | melt flow |
|---|---|---|---|---|
| | rate/index, | rate/index, | rate/index, | rate/index, |
| | 170° C., 2.16 | 170° C., 21.6 | 190° C., 2.16 | 190° C., 21.6 |
| Exp# | kg, 60 s | kg, 15 s | kg, 60 s | kg, 15 s |
| 1 | NA | NA | NA | NA |
| 2 | 13.8 g/10 min | 360 g/10 min | 22.2 g/10 min | 552 g/10 min |
| 3 | NA | NA | NA | NA |
| 4 | NA | NA | NA | NA |
| 5 | NA | NA | NA | NA |

TABLE 2I
Polymer properties

| | stress at | strain at | Young's modulus |
|---|---|---|---|
| Exp# | break [MPa] | break [%] | [MPa] |
| 1 | 34.3 ± 0.8 | 638 ± 22 | 711 ± 82 |
| 2 | 36.5 ± 1.8 | 853 ± 118 | 433 ± 32 |
| 3 | NA | NA | NA |
| 4 | NA | NA | NA |
| 5 | NA | NA | NA |
| 6A* | 31.6 ± 0.9 | 695 ± 16 | 583 ± 7.5 |
| 6B** (purified) | 35.8 ± 1.5 | 745 ± 32 | 790 ± 51 |
| 6C | NA | NA | NA |

*Average values of data shown in Tables 6A
**Average values of data shown in Tables 6B

TABLE 3
Figure Locations for Graphical Measurements of Physical Properties and/or Performance Metrics

| | | | Photo | | | | | | | | Arrhenius |
|---|---|---|---|---|---|---|---|---|---|---|---|
| | ¹H | | of | TGA | DSC | DMA | Tensile | Shear | Strain | TTS | Act. |
| Exp# | NMR | GPC | sample | trace | trace | trace | testing | viscosity | sweep | curves | Energy |
| 1 | 2 | 3 | 4 | 5, 6 | 7 | 8 | 9 | 10, 11 | NA | NA | NA |
| 2 | 12 | 13 | 14 | 15-18 | 19 | 20 | 21 | 24-31 | 22, 23 | 32-36 | 37-41 |
| 3 | 42 | 43 | 44 | 45 | 46 | NA | NA | NA | NA | NA | NA |
| 4 | 47 | 48 | 49, 52 | 50 | 51 | NA | NA | NA | NA | NA | NA |
| 5 | 53 | 54 | 55 | 56 | 57 | NA | 58 | NA | NA | NA | NA |
| 6A | 64 | 65 | NA | 66, 67 | 68 | 69 | 70 | 71 | NA | NA | NA |
| 6B | 59 | 60 | NA | 61 | 62 | NA | 63 | NA | NA | NA | NA |
| 6C | 72, 73 | 74 | 75 | 76 | 77 | NA | NA | NA | NA | NA | NA |

TABLE 4A
Stress, strain, and Young's Modulus values for three
replicates of tensile tests at 5 mm/min for PHPD
(Mn = 93.6 kDa) (Experiment #1).

| Sample | Stress | Strain | Young's |
|---|---|---|---|
| Number | (MPa) | (%) | Modulus (MPa) |
| 1 | 33.3 | 608 | 702 |
| 2 | 35.2 | 660 | 616 |
| 3 | 34.5 | 645 | 816 |
| Average | 34.3 ± 0.8 | 638 ± 22 | 711 ± 82 |

TABLE 4B
Stress, strain, and Yong's Modulus values for three
replicates of tensile tests at 5 mm/min for PHPD (Mₙ =
104 kDa, M_{w} = 133 kDa, Ð = 1.28) (Experiment #2).

| Sample | Stress | Strain | E′ |
|---|---|---|---|
| Number | (MPa) | (%) | (MPa) |
| 1 | 39.1 | 1010 | 424 |
| 2 | 35.6 | 724 | 476 |
| 3 | 34.9 | 826 | 398 |
| Average | 36.5 ± 1.8 | 853 ± 118 | 433 ± 32 |

TABLE 5A
Melt flow index (MFI) results for PHPD at 140°
C. (Mₙ = 104 kDa, M_{w} = 133 kDa, Ð =
1.28) (Experiment #2).

| 140° C. | 2.16 kg (5 min) | 21.6 kg (30 sec) |
|---|---|---|
| 1 | 0.13 g | 0.47 g |
| 2 | 0.14 g | 0.44 g |
| 3 | 0.12 g | 0.45 g |
| 4 | 0.13 g | 0.42 g |
| 5 | — | 0.42 g |
| Avg | 0.13 ± 0.007 g | 0.44 ± 0.019 g |
| MFR | 1.56 g 10 min⁻¹ | 52.8 g 10 min⁻¹ |

TABLE 5B
Melt flow index (MFI) results for PHPD at 150°
C. (Mₙ = 104 kDa, M_{w} = 133 kDa, Ð =
1.28) (Experiment #2).

| 150° C. | 2.16 kg (5 min) | 21.6 kg (30 sec) |
|---|---|---|
| 1 | 0.15 g | 0.64 g |
| 2 | 0.15 g | 0.67 g |
| 3 | 0.17 g | 0.62 g |
| 4 | 0.16 g | 0.67 g |
| 5 | — | 0.65 g |
| Avg | 0.16 ± 0.008 g | 0.65 ± 0.019 g |
| MFR | 1.92 g 10 min⁻¹ | 78.0 g 10 min⁻¹ |

TABLE 5C
Melt flow index (MFI) results for PHPD at 160°
C. (Mₙ = 104 kDa, M_{w} = 133 kDa, Ð =
1.28) (Experiment #2).

| 160° C. | 2.16 kg (90 sec) | 21.6 kg (15 s) |
|---|---|---|
| 1 | 0.20 g | 1.14 g |
| 2 | 0.19 g | 1.22 g |
| 3 | 0.22 g | 1.29 g |
| 4 | 0.25 g | 1.28 g |
| 5 | — | 1.19 g |
| Avg | 0.22 ± 0.023 g | 1.22 ± 0.06 g |
| MFR | 8.80 g 10 min⁻¹ | 293 g 10 min⁻¹ |

TABLE 5D
Melt flow index (MFI) results for PHPD at 170°
C. (Mₙ = 104 kDa, M_{w} = 133 kDa, Ð =
1.28) (Experiment #2).

| 170° C. | 2.16 kg (60 sec) | 21.6 kg (15 sec) |
|---|---|---|
| 1 | 0.22 g | 1.61 g |
| 2 | 0.23 g | 1.51 g |
| 3 | 0.23 g | 1.42 g |
| 4 | 0.22 g | 1.53 g |
| 5 | — | 1.44 g |
| Avg | 0.23 ± 0.005 g | 1.50 ± 0.07 g |
| MFR | 13.8 g 10 min⁻¹ | 360 g 10 min⁻¹ |

TABLE 5E
Melt flow index (MFI) results for PHPD at 190°
C. (Mₙ = 104 kDa, M_{w} = 133 kDa, Ð =
1.28) (Experiment #2).

| 190° C. | 2.16 kg | 21.6 kg |
|---|---|---|
| 1 | 0.39 | 2.45 |
| 2 | 0.38 | 2.22 |
| 3 | 0.35 | 2.31 |
| 4 | 0.36 | 2.58 |
| 5 | — | 2.42 |
| Avg | 0.37 ± 0.016 g | 2.30 ± 0.19 g |
| MFR | 22.2 g 10 min⁻¹ | 552 g 10 min⁻¹ |

TABLE 6A
Stress, strain, Yong's Modulus, and Toughness values for
three replicates of tensile tests at 5 mm/min for purified
PHHD obtained from the 14.7 g scale neat polymerization (Mₙ =
142 kDa, M_{w} = 193 kDa, Ð = 1.36) (Experiment #6B).

| Sample | Yield | Stress | Strain | E′ | Toughness |
|---|---|---|---|---|---|
| Number | Stress (MPa) | (MPa) | (%) | (MPa) | (MJ m⁻³) |
| 1 | 15.8 | 37.5 | 786 | 739 | 161 |
| 2 | 16.3 | 33.9 | 710 | 771 | 135 |
| 3 | 18.2 | 36.1 | 737 | 859 | 155 |
| Average | 16.8 ± 1.0 | 35.8 ± 1.5 | 745 ± 32 | 790 ± 51 | 150 ± 11 |

TABLE 6B
Stress, strain, Yong's Modulus, and Toughness values for
three replicates of tensile tests at 5 mm/min for unpurified
PHHD obtained from the 15.0 g scale neat polymerization (Mₙ =
149 kDa, M_{w} = 164 kDa, Ð = 1.09) (Experiment #6A).

| Sample | Yield | Stress | Strain | E′ | Toughness |
|---|---|---|---|---|---|
| Number | Stress (MPa) | (MPa) | (%) | (MPa) | (MJ m − 3) |
| 1 | 16.4 | 30.9 | 674 | 573 | 124 |
| 2 | 16.7 | 32.8 | 710 | 591 | 136 |
| 3 | 16.5 | 31.0 | 703 | 585 | 128 |
| Average | 16.5 ± 0.1 | 31.6 ± 0.9 | 695 ± 16 | 583 ± 7.5 | 129 ± 5.2 |

FIGS. 58A-J illustrate melt strengths of various exemplary PHPDs, according to some embodiments of the present disclosure.

### Materials and Experimental

Materials: ω-PDL monomer (i.e., macrolactone) was purchased from Millipore Sigma and thoroughly dried before use (see Experimental section). La[N(SiMe₃)₂]₃ (precatalyst 123) was purchased from Thermo Fisher Scientific, Millipore Sigma and used as received.

Anhydrous benzyl alcohol (BnOH) (initiator 125) was purchased from Millipore Sigma and used as received. Injection molding grade low-density polyethylene (LDPE, 3-4 mm granules, MFI=7.5, Product Code INEOS LDPE 19N430) was purchased from INEOS Olefins & Polymers Europe. Film grade LDPE pellets (catalog #042; density: 0.92 (23° C.); M_{w}=50,000; Melting point: 107-135° C.; Melt index: 1.0 g/10 min) was purchased from Scientific Polymer Products, Inc and used as received. [La(OBn)₃]ₓ (catalyst 147) was in situ generated according to known methods (vide infra). An example of combining initiator and precatalyst to form the catalyst is shown in Scheme 1 below for Experiment #2.

### Example for 150 g ω-PDL scale

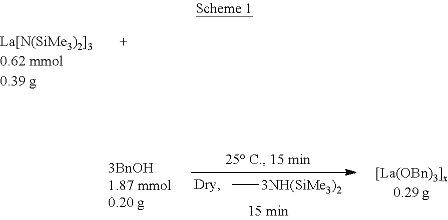

All syntheses and manipulations of air- and moisture-sensitive materials were carried out under nitrogen in flamed reactor or Schlenk-type glassware on a dual-manifold Schlenk line, or in a glovebox. Toluene and tetrahydrofuran (THF) (solvents 155) were distilled from CaH₂ under argon, degassed and stored over 4 Å molecular sieves. ω-PDL melt monomer was dried over CaH₂ while stirring for 8 h at 70° C. and distilled at 165° C. under 10-20 mTorr before use and stored at 25° C. under nitrogen atmosphere in the glovebox. CDCl₃ was dried over CaH₂, then degassed and stored over 4 Å molecular sieves. Anhydrous BnOH was stored under nitrogen atmosphere in a glovebox.

Compression Molded Film Preparation: Selected polymers (PHPD, injection molding grade LDPE and HDPE, film grade LDPE, and it-PP) were melt-compression molded into suitable films using a Carver Auto Series Plus Laboratory Press (Carver, Model 3889.1PL1000, Max Force 15 ton) with programmable electrically heated platen (EHP) temperature, complimented by air- and water-circulatory cooling control. Polymer substrates (-5 g) were placed between two non-stick Teflon sheets in a stainless-steel, rectangular (73.5×44.5×0.89 mm; length×width×thickness) mold and compressed between two 6” x 6” EHPs at 5000 psi for roughly 20-35 minutes. PHPD samples were melt processed at 120° C., while commercially purchased HDPE was melt processed at 150° C., LDPE at 120° C., and it-PP at 185° C. All samples were cooled in 15-30 minutes while under compression conditions using the water-cooling function except for HDPE which was slowly cooled to ambient temperature over the course of ˜3 h while under compression.

Characterization methods:

¹H NMR Spectra were recorded on a Bruker Advance II 400 MHz spectrometer, or a Varian Inova 400 MHz spectrometer. ¹H NMR chemical shifts were referenced to residual CHCl₃ or SiMe₄ (TMS).

Gel Permeation Chromatography (GPC): Measurements of polymer absolute weight (M_{w}), number (Mₙ), and dispersity index (Ð=M_{w}/Mₙ) values were measured by GPC. The GPC instrument consisted of an Agilent HPLC system equipped with one guard column and two PLgel 5 μm mixed-C gel permeation columns and coupled with a Wyatt DAWN HELEOS II multi (18)-angle light scattering detector, a Wyatt Optilab TrEX dRI detector, and a Wyatt Viscostar III viscometer. The experiments were performed at 40° C. using CHCl₃ as the eluent at a flow rate 1.0 mL/min and the analyses were performed using Wyatt ASTRA 7.1.2 software. Refractive index (dn/dc) value for absolute molecular weight measurements for PHPD sample (0.0327±0.0011 mL/g) was determined experimentally by batch experiments through the Wyatt Optilab TrEX dRI detector and calculated via the ASTRA 7.1.2 software. A series of polymer solutions with four or five standard concentrations (1.05, 2.1, 3.15, 4.2, and 5.25 mg/mL) were prepared in CHCl₃ and injected into the dRI detector by a Harvard Apparatus Pump 11 at a flow rate of 0.3 mL min⁻¹. The refractive index was then recorded and plotted against concentration to obtain a calibration curve. The slope from a linear fitting (both R²>0.99) was the dn/dc of the polymer.

Differential Scanning Calorimetry (DSC): Glass transition (T_{g}) and melting transition (Tₘ) temperatures were measured by differential scanning calorimetry (DSC) on Q20, TA Instrument. All T_{g} and Tₘ values were obtained from a second scan after the thermal history was removed from the first scan. The heating rate was 10° C./min and cooling rate was 10° C./min.

Thermogravimetric Analysis (TGA): Decomposition temperatures (T_{d},5%, defined by the temperature of 5% weight loss) and maximum rate decomposition temperatures (Tₘₐₓ) of the polymers were measured by thermal gravimetric analysis (TGA) on Q20, TA Instrument. Polymer samples (<10 mg) were heated at a heating rate of 10° C./min from ambient temperatures to 700° C. Values of Tₘₐₓ were obtained from derivative change (wt %/° C.) versus temperature (° C.) plots, while T_{d,5%} were obtained from wt % versus temperature (° C.) plots.

Dynamic Mechanical Analysis (DMA): Storage modulus (F, MPa), loss modulus (E”, MPa), and tan 6 (E”/IE) measurements for PHPD samples were performed on a Q800 DMA in tension film mode on rectangular specimens (1=17.2 mm, w=5.47 mm, t=0.91 mm). Sample length between grips is 12.3 mm. Temperature-ramp frequency-sweep experiments were performed at 0.2% oscillating strain at 1 Hz between −125 to 50° C. at a heating rate of 3° C. /min.

Temperatures below ambient conditions were accessed via liquid-N2 GCA tank attachment. Post-run analysis was done on TA instrument universal analysis software.

Stress/Strain Tensometry: Thin films suitable for tensile stress/strain testing were sectioned to ASTM-D638 Type-V standard tensile bar specimens (cross-section w=3.18 mm) and analyzed on an Instron 5966 universal tensometer testing system (Instron) equipped with a 10 kN load cell and operated at room temperature (˜23° C.). Individual sample thicknesses (-0.89 mm) were recorded prior to the start of testing using a Fowler 0-6” IP67 Pro-Max Model S electronic digital caliper set. Tensile bars were clamped tightly between two sets of textured grips (separation−28 mm) and pulled at a constant strain rate of 5 mm/min to sample failure. Reported measurements are obtained from the Instron readout in cooperation with BlueHill Universal software (Instron) normalizing force/displacement response to stress/strain, and reported curves were generated from an average of a minimum of 3-5 individual samples for reproducibility, with error margins included accordingly. Young's modulus (E, MPa), ultimate strength (σ_{B}, MPa), yield strength (MPa), and elongation at break or fracture strain (ε_{B}, %) were obtained from software analysis. Reported toughness values (U_{T}; MJ/m³) were obtained by manual calculation (integration) of the area under the averaged stress/strain curve.

Oscillatory Shear Rheology: Bulk flow experiments were performed on a Discovery Series HR (Hybrid Rheometer) - 2 (TA Instruments). The rheometer was operated with 25 mm parallel geometry plates between 110-200° C. under nitrogen gas flow (30 psi) and in cooperation with the TRIOS software (TA Instruments). Samples were loaded between two 25 mm-diameter flat-plate steel electrically heated platen (EHP) loading discs, heated to the designated temperatures, and trimmed to a parallel fit. All experiments were performed within 0±0.2 N of axial force. The linear viscoelastic region (LVR) was measured by strain sweep screening at 10 rad/s at the temperature (140° C.) to obtain the strain-limitations for further oscillatory experiment validity. Oscillatory frequency sweeps were performed from 0.1 to 600 rad/s to a shear strain of 1% at temperatures from 110-200° C. in increments of 10° C. to simultaneously record dynamic moduli (G″ and G″, Pa) and complex viscosity (η*, Pa s). All 10 individual curves were overlayed, and WLF α-shifting was automated by the TRIOS software under the selected reference temperature TRef (110-200) ° C. to generate the time-temperature-super-positioned master curves and to obtain Arrhenius activation energy.

Melt strength and stretch ratio measurements: Melt strength and stretch ratio measurements were performed on a Goettfert Rheotens instrument. The Rheotens measures the extensional properties of polymer melts by drawing a vertical melt strand at a constant extension rate. The force needed to elongate the strand is measured and used to calculate other properties of interest. Barrel temperature was tested at 145° C., 155° C., 165° C., 175° C. and 190° C. Melt strength was taken as the ultimate stress upon filament break. Elongation ratio (V/Vₛ) is the relative pull velocity (V) with respect to the average exit velocity of the die (Vₛ). Measurements were performed in triplicate at each temperature

Melt Flow Index (Melt Flow Rate): Melt Flow Index (MFI) also known as Melt Flow Rate (MFR) of the polymers were determined per ASTM D1238. MFI values were measured at 140° C., 150° C., 160° C., 170° C., and 190° C. at two different weights of 2.16 kg and a 21.6 kg. Melt flow rate (MFR) was obtained on an NXR - 400B Melt Flow Indexer at temperatures between 140-190° C. at force loadings of 2.16 kg and 21.6 kg. PHPD (25 g, 104 kDa) was manually cut into small (˜500 mg) chunks and added to the indexer. The polymer was given 5 minutes to undergo transition to a viscous melt after which the mass plates were placed onto the charging rod.

A timer was immediately started upon mass loading, at which point melted PHPD began flowing through the die. Strips of polymer filament were cut at consistent intervals of 2.5 minutes, 1 minutes, 30 s, or 15 s depending on the rate of flow. Finally, an averaged mass was recorded from each cut filament converted to MFR by normalizing to 10 minutes of run time to achieve the value in 10 g-min⁻¹.

PHPD Extrusion and Pelletization Process: PHPD (500 g, 104 kDa) was converted to pellets prior to blown-film experiments. Specifically, the PHPD was manually cut into smaller chunks (˜10-25 g) followed by addition to a Filabot Ex2 polymer melt extruder equipped with a 1.75 mm filament die (Serial No. EX00882) at 160° C. and −10 rpm screw speed. PHPD was extruded in several batches, during which time cooled (ambient) filaments were fed into a Filabot Pelletizer (Serial No. FCR0132) at a lower end cutting rate to produce cleanly furnished pellets.

### EXAMPLES

Example 1. A polymer comprising Structure (I),

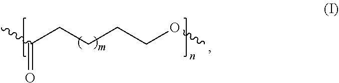

wherein: m is between 11 and 16 or between 8 and 20, n is between 2 and 5,000, and [symbol] is a covalent bond.

Example 2. The polymer of Example 1, further comprising a number average molecular weight (Mₙ) between 50 kDa and 500 kDa or between 70 kDa and 150 kDa.

Example 3. The polymer of Example 1 and/or Example 2, further comprising a polydispersity (Ð) between 1.01 and 2.5 or between 1.1 and 1.4 (dimensionless).

Example 4. The polymer of any one of Examples 1-3, further comprising a melting temperature (Tₘ) between 80.0° C. and 115.0° C. or between 90.0° C. and 100.0° C. or between 94.0° C. and 96.0° C.

Example 5. The polymer of any one of Examples 1-4, further comprising an enthalpy of fusion (ΔHₘ) between 60 J/g and 200 J/g or between 120 J/g and 140 J/g.

Example 6. The polymer of any one of Examples 1-5, further comprising a crystallization temperature (T_{c}) between 60.0° C. and 150.0° C. or between 74.0° C. and 80.0° C.

Example 7. The polymer of any one of Examples 1-6, further comprising an enthalpy of crystallization (ΔH_{c}) between 80 J/g and 200 J/g or between 109 J/g and 131 J/g.

Example 8. The polymer of any one of Examples 1-7, further comprising a degradation temperature (T_{d}) between 360° C. and 500° C. or between 360° C. and 401° C., wherein the polymer exhibits less than or equal to about 5% weight loss when heated to T_{d}.

Example 9. The polymer of any one of Examples 1-8, further comprising a maximum degradation temperature (T_{d},maₓ) between 420° C. and 600° C. or between 420° C. and 450° C., wherein the polymer exhibits greater than about 50% weight loss when heated to T_{d},maₓ.

Example 10. The polymer of any one of Examples 1-9, further comprising a melt strength value of at least 3 cN measured at 175° C.

Example 11. The polymer of any one of Examples 1-10, further comprising a melt strength value of at least 5 cN measured at 165° C.

Example 12. The polymer of any one of Examples 1-11, further comprising a melt strength value of at least 6 cN measured at 155° C.

Example 13. The polymer of any one of Examples 1-12, further comprising a melt strength value of at least 7 cN measured at 145° C.

Example 14. The polymer of any one of Examples 1-13, further comprising a stress at break between 10 MPa and 80 MPa, between 20 MPa and 60 MPa, or between 30 MPa and 40 MPa.

Example 15. The polymer of any one of Examples 1-14, further comprising a strain at break between 200% and 1500%, between 300% and 1200%, or between 600% and 900%.

Example 16. The polymer of any one of Examples 1-15, further comprising a Young's modulus between 100 MPa and 1500 MPa or between 400 MPa and 750 MPa.

Example 17. The polymer of any one of Examples 1-16, further comprising an end-group comprising at least one of a hydrogen atom, an alkyl group, an alkoxy group, an aromatic group, or a benzyloxy group.

Example 18. A composition comprising: at least one of a heat stabilizer, an anti-oxidant, a processing aid, or an anti-blocking agent; and a polymer comprising Structure (I),

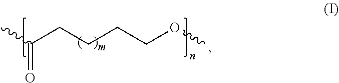

wherein: m is between 11 and 16 or between 8 and 20, n is between 2 and 5,000, and [symbol] is a covalent bond.

[symbol]

Example 19. The composition of Example 18, wherein the composition is in the form of at least one of a granule or a pellet.

Example 20. The composition of Example 18 and/or 19, wherein the composition is in the form of a film that is manufactured by at least one of a blown process, a molded process, or a cast process.

Example 21. The composition of any one of Examples 18-20, wherein the film has an average thickness between 2.5 μm and 250 μm, or between 20 μm and 120 μm, or between m and 100 m.

Example 22. The composition of any one of Examples 18-21, wherein the film comprises a 2% secant modulus between 150 MPa and 750 MPa or between 300 MPa and 500 MPa.

Example 23. The composition of any one of Examples 18-22, wherein the film comprises a heat seal strength between ION and 40 N or between 15 N and 30 N.

Example 24. The composition of any one of Examples 18-23 wherein the film comprises a clarity between 60% and 100% or between 70% and 100%.

Example 25. The composition of any one of Examples 18-24, wherein the film comprises a transmittance between 60% and 100% or between 80% and 100%.

Example 26. The composition of any one of Examples 18-25, wherein the film comprises a haze less than 60% or less than 50%.

Example 27. A method of making a polymer, the method comprising: polymerizing a cyclic molecule having a structure according to (II) to produce the polymer having a structure according to (I), wherein:

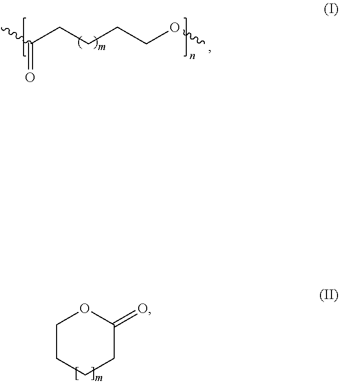

m is between 11 and 17 or between 8 and 20, n is between 1 and 5,000, [symbol] is a covalent bond, and the polymerizing is performed neat.

Example 28. The method of Example 27, wherein the polymerizing results in between 50% and 100% conversion or between 80% and 100% conversion or between 98.0% and 99.9 conversion of the cyclic molecule to the polymer.

Example 29. The method of Example 27 and/or 28, wherein the polymer is further characterized by a polydispersity (Ð) between 1.01 and 2.5 or between 1.1 and 1.4 (dimensionless).

Example 30. The method of any one of Examples 27-29, wherein the polymerizing is performed at a temperature between 40° C. and 200° C. or between 70° C. and 110° C.

Example 31. The method of any one of Examples 27-30, wherein the polymerizing is performed at the temperature for a period of time between 1 minute and 12 hours or between 30 minutes and 6 hours.

Example 32. The method of any one of Examples 27-31, wherein the polymerizing is performed using a catalyst.

Example 33. The method of any one of Examples 27-32, wherein the catalyst comprises [La(OBn)₃]ₓ and 2≤x≤5.

Example 34. The method of any one of Examples 27-33, wherein the polymerizing is performed using at least one of a stirred tank reactor, in an extruder, or a combination thereof.

Example 35. The method of any one of Examples 27-34, wherein the extruder comprises at least one of a single-screw extruder, a twin-screw extruder, or a combination thereof.

Example 36. The method of anyone of Examples 27-35, further comprising, prior to the polymerizing, combining a precatalyst and an initiator to form a solution comprising the catalyst.

Example 37. The method of any one of Examples 27-36, wherein the precatalyst comprises at least one of La[N(SiMe₃)₂]₃, SnOct₂ or P₄-t-Bu, or a combination thereof.

Example 38. The method of any one of Examples 27-37, wherein the initiator comprises an alcohol.

Example 39. The method of any one of Examples 27-38, wherein the alcohol comprises at least one of benzyl alcohol (BnOH), iso-propyl alcohol, or a combination thereof.

Example 40. The method of any one of Examples 27-39, wherein the combining is performed with a precatalyst to initiator mass ratio (precatalyst:initiator) between 1:5 and 5:1 or between 1.5:1 and 2.5:1.

Example 41. The method of any one of Examples 27-40, wherein the polymerizing is performed at a monomer to initiator mass ratio (monomer:initiator) between 100 and 5,000 or between 700 and 2,000.

Example 42. The method of any one of Examples 27-41, further comprising, during and/or after the combining, treating the solution, wherein the treating removes a volatile component.

Example 43. The method of any one of Examples 27-42, wherein the volatile component comprises an amine.

Example 44. The method of any one of Examples 27-43, wherein the treating comprises applying a vacuum to the solution.

Example 45. The method of any one of Examples 27-44, further comprising, after the combining, adding a solvent to the solution at a concentration between about 0.1 wt % and 5.0 wt % solvent relative to the total mass of the solution.

Example 46. The method of any one of Examples 27-45, wherein the solvent comprises toluene.

Example 47. The method of anyone of Examples 27-46, further comprising, prior to the polymerizing, melting the cyclic molecule to form a liquid comprising the cyclic molecule.

Example 48. The method of any one of Examples 27-47, further comprising, mixing the liquid with the solution, thereby initiating the polymerizing.

Example 49. A method of using a composition to produce a film, the method comprising: the composition comprises a polymer comprising Structure (I),

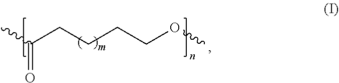

wherein: m is between 11 and 16 or between 8 and 20, n is between 2 and 5,000, and [symbol] is a covalent bond; directing the polymer to a blown film extruder, wherein: the extruder is operated with: a barrel temperature between 150° C. and 250° C. or between 200° C. and 240° C.; a die temperature between 145° C. and 245° C. or between 195° C. and 235° C.; and an extruder speed between 60 RPM and 300 RPM or between 160 RPM and 180 RPM; and the extruder is a conical single screw extruder.

Example 50. The method of Example 49, wherein the extruder is operated at a Blow-Up Ratio (BUR) between 2.0 and 3.0, or between 1.5 and 5.0, or between 2.3 and 3.5.

Example 51. The method of Example 49 and/or 50, wherein the extruder is operated at a Drawdown Ratio (DDR) between 3.0 and 6.0, or between 2.0 and 8.0, or between 4.5 and 6.5.

The foregoing discussion and examples have been presented for purposes of illustration and description. The foregoing is not intended to limit the aspects, embodiments, or configurations to the form or forms disclosed herein. In the foregoing Detailed Description for example, various features of the aspects, embodiments, or configurations are grouped together in one or more embodiments, configurations, or aspects for the purpose of streamlining the disclosure. The features of the aspects, embodiments, or configurations, may be combined in alternate aspects, embodiments, or configurations other than those discussed above. This method of disclosure is not to be interpreted as reflecting an intention that the aspects, embodiments, or configurations require more features than are expressly recited in each claim. Rather, as the following claims reflect, inventive aspects lie in less than all features of a single foregoing disclosed embodiment, configuration, or aspect. While certain aspects of conventional technology have been discussed to facilitate disclosure of some embodiments of the present invention, the Applicants in no way disclaim these technical aspects, and it is contemplated that the claimed invention may encompass one or more of the conventional technical aspects discussed herein.

Thus, the following claims are hereby incorporated into this Detailed Description, with each claim standing on its own as a separate aspect, embodiment, or configuration.

What is claimed is:

1. A polymer comprising Structure (I) 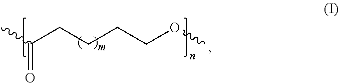
wherein:
m is between 8 and 20,
n is between 2 and 5,000, and [symbol]
is a covalent bond.

2. The polymer of claim 1, further comprising a number average molecular weight (M˜) between 50 kDa and 500 kDa.

3. The polymer of claim 1, further comprising a polydispersity (Ð) between 1.1 and 1.4.

4. The polymer of claim 1, further comprising a melting temperature (Tₘ) between 80.0° C. and 115.0° C.

5. The polymer of claim 4, further comprising an enthalpy of fusion (ΔHₘ) between 60 J/g and 200 J/g.

6. The polymer of claim 1, further comprising a crystallization temperature (T_{c}) between 60.0° C. and 150.0° C.

7. The polymer of claim 6, further comprising an enthalpy of crystallization (ΔH_{c}) between 80 J/g and 200 J/g.

8. The polymer of claim 1, further comprising a stress at break between 10 MPa and 80 MPa

9. The polymer of claim 1, further comprising a strain at break between 200% and 1500%.

10. The polymer of claim 1, further comprising a Young's modulus between 100 MPa and 1500 MPa.

11. A composition comprising:
at least one of a heat stabilizer, an anti-oxidant, a processing aid, or an anti-blocking agent; and
a polymer comprising Structure (I) 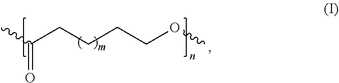
wherein:
m is between 8 and 20,
n is between 2 and 5,000, and [symbol]
is a covalent bond.

12. The composition of claim 11, wherein the composition is in the form of a film.

13. The composition of claim 12, wherein the film has an average thickness between 2.5 μm and 250 μm.

14. The composition of claim 12 wherein the film has a clarity value between 60% and 100%.

15. The composition of claim 12, wherein the film has a haze value less than 60%.

16. A method of making a polymer, the method comprising:
polymerizing a cyclic molecule having a structure according to (II) to produce the polymer having a structure according to (I), wherein: 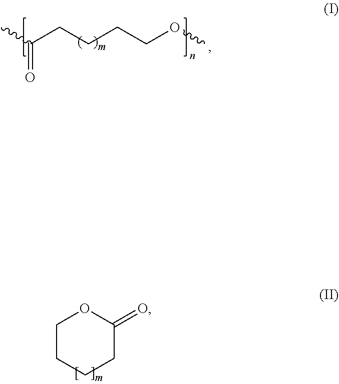
m is between 8 and 20,
n is between 1 and 5,000, [symbol]
is a covalent bond, and
the polymerizing is performed neat.

17. The method of claim 16, wherein the polymerizing results in between 80% and 100% conversion of the cyclic molecule.

18. The method of claim 16, wherein the polymer is further characterized by a polydispersity (Ð) between 1.1 and 1.4.

19. The method of claim 27, wherein the polymerizing is performed at a temperature between 70° C. and 110° C.

20. A method of using a composition to produce a film, the method comprising:
the composition comprises a polymer comprising Structure (I) 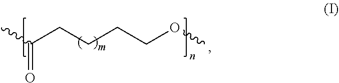
wherein:
m between 8 and 20,
n is between 2 and 5,000, and [symbol]
is a covalent bond;
directing the polymer to a blown film extruder, wherein:
the extruder is operated with:
a barrel temperature between 150° C. and 250° C.;
a die temperature between 145° C. and 245° C.; and
an extruder speed between 60 RPM and 300 RPM; and
the extruder is a conical single screw extruder.
